(19) United States
(12) Patent Application Publication
(10) Pub. No.: US 2009/0288408 A1
(43) Pub. Date: Nov. 26, 2009

(54) HYDRAULIC CIRCUIT, ENERGY RECOVERY DEVICE, AND HYDRAULIC CIRCUIT FOR WORK MACHINE

(75) Inventors: Shoji Tozawa, Tokyo (JP); Madoka Binnaka, Tokyo (JP); Hideto Furuta, Tokyo (JP)

Correspondence Address: DARBY & DARBY P.C., P.O. BOX 770, Church Street Station, New York, NY, 10008-0770, US

(73) Assignee: SHIN CATERPILLAR MITSUBISHI LTD., Tokyo (JP)

(21) Appl. No.: 11/912,060

(22) PCT Filed: Feb. 27, 2006
(86) PCT No.: PCT/JP2006/303564

§ 371 Date: Oct. 19, 2007

(30) Foreign Application Priority Data
Jun. 6, 2005 (JP) 2005-166177
Jun. 6, 2005 (JP) 2005-166178
Jun. 6, 2005 (JP) 2005-166179
Jun. 6, 2005 (JP) 2005-166180

(51) Int. Cl. F15B 21/14; F15B 13/044; H02K 7/18

(52) U.S. Cl. 60/435; 60/484; 60/459; 290/1 A

(57) ABSTRACT

A hydraulic circuit that enables smooth absorption of the energy of a return fluid from a hydraulic actuator by means of an energy recovery motor. A return fluid passage to which the fluid discharged from a boom cylinder is branched is provided at the tank passage side of a solenoid valve of a boom control circuit. The return fluid passage comprises two return passages, which are provided with a flow rate ratio control valve for controlling a ratio of fluid that branches off into the return passages. The flow rate ratio control valve is comprised of a solenoid valve disposed in the return passage, which is provided with an energy recovery motor, and a solenoid valve disposed in the return passage, which branches off the upstream side of the solenoid valve.

### CROSS REFERENCE TO RELATED APPLICATIONS

This is a U.S. national phase application under 35 U.S.C. § 371 of International Patent Application No. PCT/JP2006/303564, filed Feb. 27, 2006 and claims the benefit of Japanese Application No. 2005-166177, filed Jun. 6, 2005; Japanese Application No. 2005-166178, filed Jun. 6, 2005; Japanese Application No. 2005-166179, filed Jun. 6, 2005 and Japanese Application No. 2005-166180, filed Jun. 6, 2005. The International Application was published in Japanese on Dec. 14, 2006 as International Publication No. WO 2006/132010 under PCT Article 21(2). The contents of all the above applications are incorporated herein in their entirety.

### TECHNICAL FIELD

The present invention relates to a hydraulic circuit provided with an energy recovery motor; an energy recovery device; and a hydraulic circuit for a work machine provided with a boom assist.

### BACKGROUND OF THE INVENTION

A driving system for a work machine, such as a hydraulic excavator, typically includes an electric generator to be driven by an engine, and an electric power storage device for storing electric power generated by the generator. An electric motor or a motor generator to be operated by power supplied from either one of or both the generator and the electric power storage device is also provided and serves to drive a pump or a pump motor. For example, a boom cylinder driving circuit is a closed circuit including a bi-directional type pump motor and a motor generator. The bi-directional type pump motor is adapted to function as a pump for feeding hydraulic fluid and also function as a hydraulic motor driven by hydraulic fluid fed thereto. The motor generator is adapted to be driven by electric power supplied from the generator or the electric power storage device so as to function as an electric motor for driving the pump motor and also adapted to be driven by the pump motor so as to function as a generator for generating electric power (e.g. See Japanese Laid-open Patent Publication No. 2004-190845 (page 7, page 16, and FIG. 1)).

As an example of conventional art, a driving system for a work machine in which a plurality of assist circuits for feeding hydraulic fluid to one another to make up a shortage in the hydraulic fluid are disposed between a plurality of driving circuits that serve to drive a plurality of hydraulic actuators of a work machine. The aforementioned driving circuits drive the hydraulic actuators by means of hydraulic pressure generated by a pump or a pump motor. The assist circuits are designed such that, for example, in the excavation mode during excavation by a hydraulic excavator, supplementary hydraulic oil is fed from a boom cylinder driving circuit, which has a relatively low flow rate requirement, to a stick cylinder driving circuit; in a turn-and-raise mode, supplementary hydraulic oil is fed from a bucket cylinder driving circuit, which has a relatively low flow rate requirement, to the boom cylinder driving circuit, which is in need of flow rate; and in a turn-and-lower mode, supplementary hydraulic oil is fed from a bucket cylinder driving circuit, which has a relatively low flow rate requirement, to the stick cylinder driving circuit, which is in need of flow rate (e.g. See Japanese Laid-open Patent Publication No. 2004-190845 (page 7, page 16, and FIG. 1).

### SUMMARY OF THE INVENTION

The driving system for a work machine described above includes a pump motor disposed in the closed circuit of the boom cylinders. Therefore, when functioning as a hydraulic motor, the pump motor suddenly starts due to emergence of flow of return fluid from the boom cylinders and halts due to cessation of the return fluid, causing a shock. Furthermore, the pump motor applies a load to the boom cylinders. As this load fluctuates depending on whether the pump motor is in operation or at a standstill, it hinders stable functioning of the boom cylinders.

Furthermore, the aforementioned combination of a pump motor and a motor generator is limited to a closed circuit and cannot be applied to an open circuit that serves to direct the return fluid discharged from hydraulic actuators back to a tank.

The conventional driving system described above presents another problem in that the assist circuits, which serve to feed hydraulic fluid to one another to make up a shortage in the hydraulic fluid, are sometimes unable to feed a sufficient amount of supplementary hydraulic fluid. For example, during a boom raising action, in which the boom cylinders of a hydraulic excavator are extended to raise the boom, it may occur that a sufficient hydraulic fluid rate required by the boom cylinders with a large diameter cannot be ensured, resulting in an undesirable decrease in operation speed.

Furthermore, as a conventional travel system drives a crawler belt by means of an electric motor through a deceleration mechanism, it is not possible to provide the travel system with an assist circuit for feeding supplementary fluid.

In order to solve the above problems, an object of the invention is to provide a hydraulic circuit that enables smooth absorption of the energy of a return fluid from a hydraulic actuator by means of an energy recovery motor, as well as stable functioning of the hydraulic actuator. Another object of the invention is to provide an energy recovery device wherein the energy of return fluid discharged from a hydraulic actuator can be effectively recovered even in an open circuit. Yet another object of the invention is to provide a hydraulic circuit for a work machine that enables supply of a significantly high flow rate of a hydraulic fluid to the head side of a boom cylinder. Yet another object of the invention is to provide a hydraulic circuit for a work machine that enables supply of a sufficiently high flow rate of a hydraulic fluid to the travel systems as well.

The present invention relates to a hydraulic circuit having a return passage through which return fluid discharged from a hydraulic actuator flows, an energy recovery motor provided in the return passage and adapted to be driven by energy contained in the return fluid, another return passage that branches off the first mentioned return passage at a location upstream of the energy recovery motor, and a flow rate ratio control valve for controlling a flow rate ratio of a flow rate of the return fluid in the first mentioned return passage and a flow rate of the return fluid in the other return passage.

The present invention also relates to a hydraulic circuit as described above, wherein the flow rate ratio control valve comprises a solenoid valve for controlling a flow rate of the return fluid in the first mentioned return passage and another solenoid valve for controlling a flow rate of the return fluid in the other return passage.

The present invention relates to a hydraulic circuit as above, wherein the hydraulic actuator is a boom cylinder for vertically pivoting a boom of a work equipment that is attached to a machine body of a work machine, and the energy recovery motor is disposed in a return passage provided for hydraulic fluid from the boom cylinder.

The present invention can also relate to an energy recovery device including a hydraulic actuator, an energy recovery motor, a motor generator, and a clutch. The hydraulic actuator is adapted to be driven by hydraulic fluid supplied from a pump. The energy recovery motor is adapted to be driven by energy contained in the return fluid discharged from the hydraulic actuator. The motor generator is adapted to be driven by the energy recovery motor so as to function as a generator for feeding electric power to an electric power storage device as well as be driven by electric power fed from the electric power storage device so as to function as an electric motor. The clutch serves to transmit power from the motor generator to the pump when the motor generator is functioning as an electric motor and disengage the motor generator from the pump when the motor generator is functioning as a generator.

The present invention relates to an energy recovery device as described above, wherein the hydraulic actuator is a boom cylinder for vertically pivoting a boom of a work equipment that is attached to a machine body of a work machine, and the energy recovery motor is disposed in a return passage provided for hydraulic fluid from the boom cylinder.

The present invention relates to a hydraulic circuit for a work machine provided with a work equipment having a boom, a stick, and a bucket that are sequentially connected and adapted to be pivoted by a boom cylinder, a stick cylinder, and a bucket cylinder respectively, wherein the hydraulic circuit comprises a boom cylinder hydraulic fluid feeding passage; a bucket cylinder hydraulic fluid feeding passage; a stick cylinder hydraulic fluid feeding passage; a boom assist pump; a solenoid valve between bucket and boom; a circuit-to-circuit communicating passage between stick and boom; and a solenoid valve between stick and boom. The aforementioned boom cylinder is adapted to receive hydraulic fluid from a plurality of main pumps comprising a first main pump and a second main pump. The boom cylinder hydraulic fluid feeding passage serves to feed hydraulic fluid from the first main pump to the boom cylinder. The bucket cylinder hydraulic fluid feeding passage branches off the boom cylinder hydraulic fluid feeding passage and serves to feed hydraulic fluid to the bucket cylinder. The stick cylinder hydraulic fluid feeding passage serves to feed hydraulic fluid from the second main pump to the stick cylinder. The boom assist pump, together with the first main pump, serves to feed hydraulic fluid to the boom cylinder hydraulic fluid feeding passage. The solenoid valve between bucket and boom is disposed in the boom cylinder hydraulic fluid feeding passage, at a location between the branching point of the bucket cylinder hydraulic fluid feeding passage and a point at which a passage from the boom assist pump joins the boom cylinder hydraulic fluid feeding passage. The solenoid valve between bucket and boom is adapted to shift between a position for enabling the hydraulic fluid that would otherwise be fed to the bucket cylinder to be fed to the boom cylinder in a one-way direction and a position for interrupting the flow of fluid. The circuit-to-circuit communicating passage between stick and boom provides fluid communication from the stick cylinder hydraulic fluid feeding passage to the head-side of the boom cylinder. The solenoid valve between stick and boom is disposed in the circuit-to-circuit communicating passage between stick and boom and adapted to shift between a position for enabling the hydraulic fluid that would otherwise be fed to the stick cylinder to be fed to the head-side of the boom cylinder in a one-way direction and a position for interrupting the flow of fluid.

The present invention can also relate to a hydraulic circuit for a work machine provided with a work equipment having a boom to be pivoted by a boom cylinder, which is adapted to receive hydraulic fluid from a plurality of main pumps including a first main pump and a second main pump, wherein the hydraulic circuit has a boom cylinder hydraulic fluid feeding passage; a boom assist pump; a solenoid valve, another solenoid valve; a pair of travel motors for traveling; and a straight travel valve. The boom cylinder hydraulic fluid feeding passage serves to feed hydraulic fluid from the first main pump to the boom cylinder. The boom assist pump, together with the first main pump, serves to feed hydraulic fluid to the boom cylinder hydraulic fluid feeding passage. The first mentioned solenoid valve is adapted to shift between a communicating position for enabling hydraulic fluid discharged from the boom assist pump to merge with hydraulic fluid discharged from the first main pump, and a position for interrupting the flow of fluid. The second mentioned solenoid valve is adapted to shift between a communicating position for enabling hydraulic fluid discharged from the first main pump to merge with hydraulic fluid discharged from the second main pump, and a position for interrupting the flow of fluid. The straight travel valve is disposed in a passage that enables the first and second main pumps to communicate with the pair of travel motors. The straight travel valve is adapted to shift between a high-speed travel position for enabling, when the two solenoid valves are at their respective communicating positions, supplementary fluid received from the boom assist pump through the two solenoid valves to merge with hydraulic fluid fed from the first main pump and the second main pump to the pair of travel motors, and a straight travel position for feeding equally divided volume of hydraulic fluid from either the first main pump or the second main pump to the pair of travel motors.

The present invention also relates to a hydraulic circuit for a work machine as described above, wherein the hydraulic circuit further includes an energy recovery motor, a motor generator, and a clutch. The energy recovery motor is adapted to be driven by energy contained in the return fluid discharged from the boom cylinder. The motor generator is adapted to be driven by the energy recovery motor so as to function as a generator for feeding electric power to an electric power storage device as well as be driven by electric power fed from the electric power storage device so as to function as an electric motor. The clutch serves to transmit power from the motor generator to the boom assist pump when the motor generator is functioning as an electric motor and disengage the motor generator from the boom assist pump when the motor generator is functioning as a generator.

According to the present invention, the energy recovery motor is provided in one of the return passages through which the return fluid discharged from the hydraulic actuator flows, and the flow rate ratio control valve controls a flow rate ratio of a flow rate of the return fluid passing through the energy recovery motor and a flow rate of the return fluid in the other return passage, which branches off the first mentioned return passage at a location upstream of the energy recovery motor. Therefore, the configuration according to the present invention is capable of gradually increasing the flow rate proportion of the fluid distributed towards the energy recovery motor side from the moment the return fluid starts to flow from the hydraulic actuator, thereby preventing the occurrence of shock, as well as ensuring stable function of the hydraulic actuator by preventing a sudden change in load to the hydraulic actuator.

According to the present invention, the two solenoid valves can be disposed at desired, separate locations in the two return passages respectively. Furthermore, the present invention also enables control of an aperture of each respective return passage separately and independently of each other.

According to the present invention, when the boom of the work equipment, which is attached to the machine body of the work machine, descends due to its own weight, the energy recovery motor is capable of smoothly absorbing the energy of the return fluid discharged from the head side of the boom cylinder. The invention also enables stable descending action of the boom due to its own weight by preventing an undesirable change in load to the head side of the boom cylinder.

According to the present invention, disengaging the clutch causes the energy recovery motor, which is being driven by the return fluid discharged from the hydraulic actuator, to efficiently input driving power to the motor generator, which is under no-load condition, so that the generated electric power is stored in the electric power storage device. When the clutch is engaged, electric power fed from the electric power storage device enables the motor generator to function as an electric motor to drive the pump so that hydraulic fluid is fed from the pump to the hydraulic actuator. Thus, energy of the return fluid discharged from the hydraulic actuator can be effectively recovered even in an open circuit.

According to the present invention, when the boom of the work equipment, which is attached to the machine body of the work machine, descends due to its own weight, the energy of the return fluid discharged from the head side of the boom cylinder can be absorbed by the energy recovery motor and the motor generator and stored in the electric power storage device.

According to the present invention, hydraulic fluid that would otherwise be fed from the first main pump to the bucket cylinder can be fed to the boom cylinder through the solenoid valve between bucket and boom; hydraulic fluid that would otherwise be fed from the second main pump to the stick cylinder can be fed to the head-side of the boom cylinder through the solenoid valve between stick and boom; and hydraulic fluid can be fed from the boom assist pump to the boom cylinder. By thus feeding a significantly high flow rate of hydraulic fluid to the head side of the boom cylinder, it is possible to increase the speed of boom raising action and improve working efficiency. Furthermore, given hydraulic pressures respectively required by the bucket cylinder and the stick cylinder can be ensured by shifting the solenoid valves to their respective positions for interrupting the flow of fluid.

According to the present invention, when the straight travel valve is at the straight travel position, equally divided volume of hydraulic fluid is fed from either the first main pump or the second main pump to the two travel motors, thereby enabling the work machine to travel straight. When the straight travel valve is at the high-speed travel position, the two solenoid valves can be shifted to their respective communicating positions to enable the supplementary hydraulic fluid discharged from the boom assist pump to be fed through both solenoid valves and merged with the hydraulic fluid fed from the first main pump and the second main pump to the two travel motors. This feature of the invention ensures supply of hydraulic fluid required for high speed travel, and enables the main pumps to be made compact.

According to the present invention, disengaging the clutch causes the energy recovery motor, which is being driven by the return fluid discharged from the boom cylinder, to efficiently input driving power to the motor generator, which is under no-load condition, so that the generated electric power is stored in the electric power storage device. When the clutch is engaged, electric power fed from the electric power storage device enables the motor generator to function as an electric motor to drive the boom assist pump so that hydraulic fluid is fed from the boom assist pump to the boom cylinder. Thus, energy of the return fluid discharged from the boom cylinder can be effectively recovered even in an open circuit.

### BRIEF DESCRIPTION OF THE DRAWINGS

FIG. 1 is a circuit diagram showing a hydraulic circuit according to an embodiment of the present invention.

FIG. 2 is a side view of a work machine that employs the aforementioned hydraulic circuit.

FIG. 3 is a circuit diagram showing a hydraulic circuit according to another embodiment of the present invention.

FIG. 4 is a circuit diagram showing a hydraulic circuit according to a further embodiment of the present invention.

FIG. 5 is a circuit diagram showing a hydraulic circuit according to an embodiment of the present invention.

FIG. 6 is a circuit diagram showing a hydraulic circuit according to another embodiment of the present invention.

FIG. 7 is a circuit diagram showing a hydraulic circuit according to a further embodiment of the present invention.

FIG. 8 is a block diagram showing a variant of a hybrid drive system used in a hydraulic circuit according to any one of the aforementioned embodiments of the present invention.

### DETAILED DESCRIPTION OF THE INVENTION

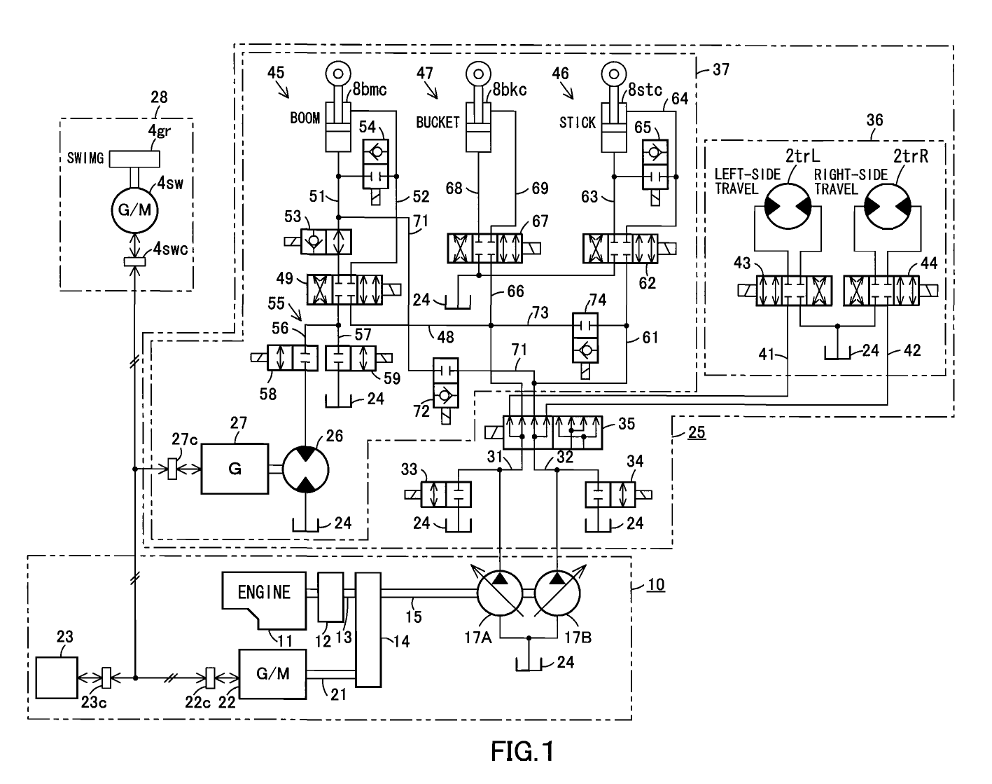

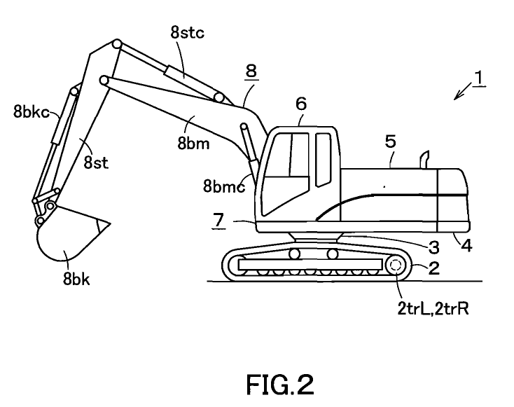

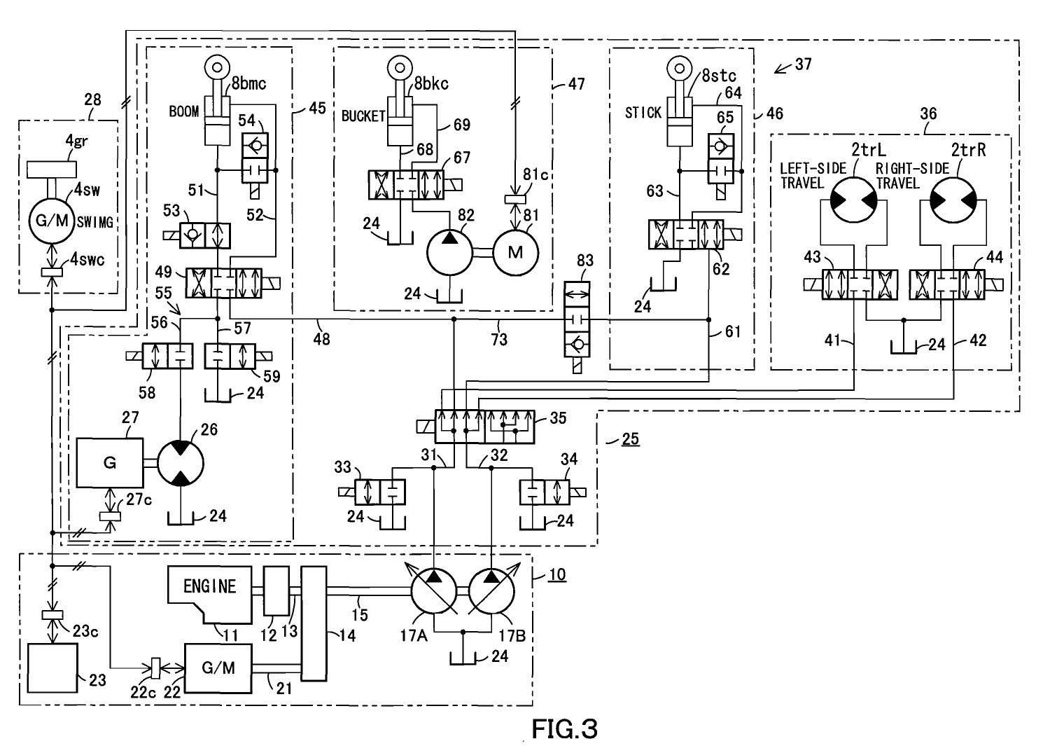

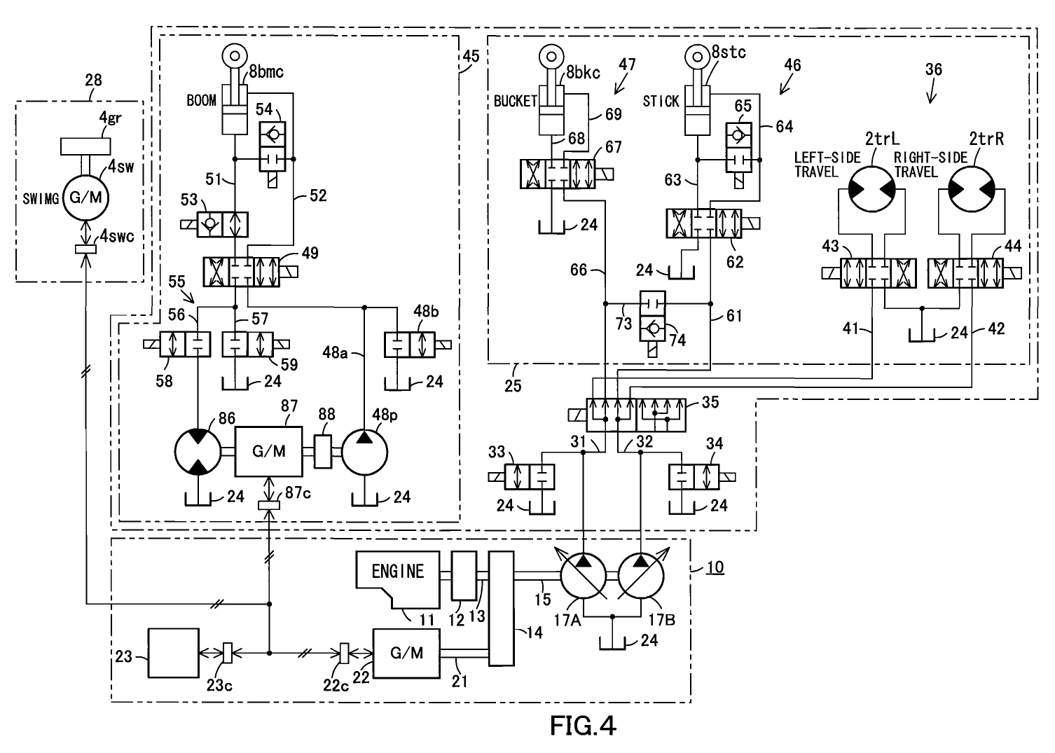

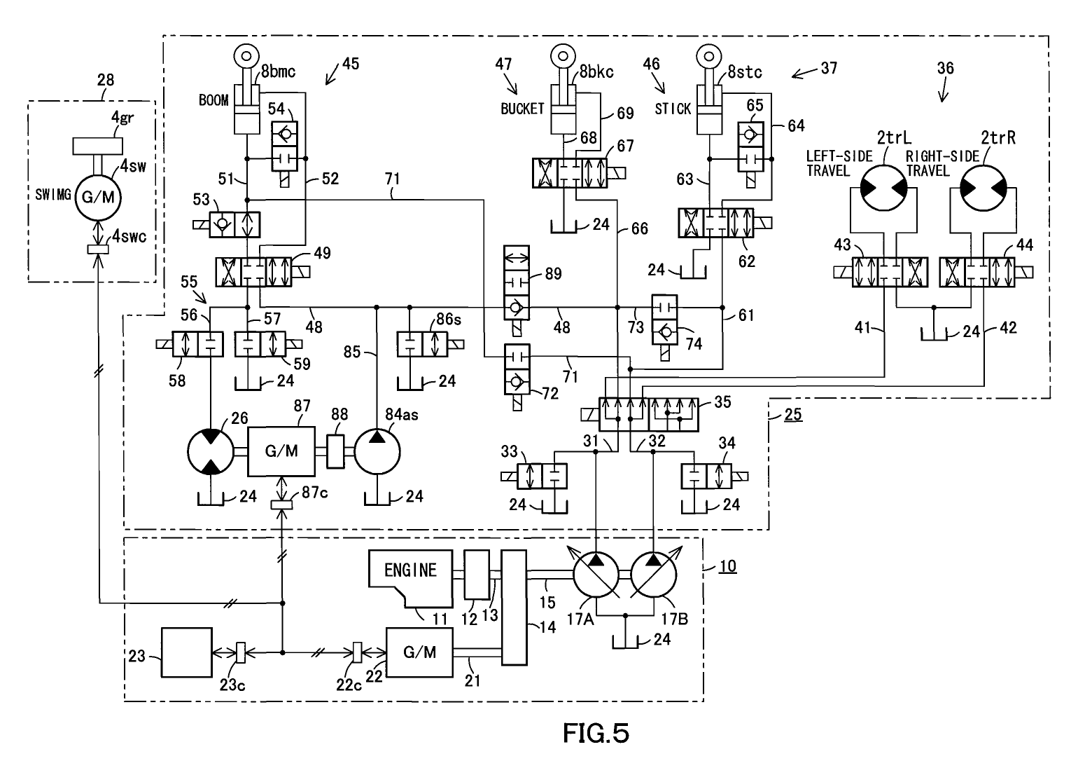

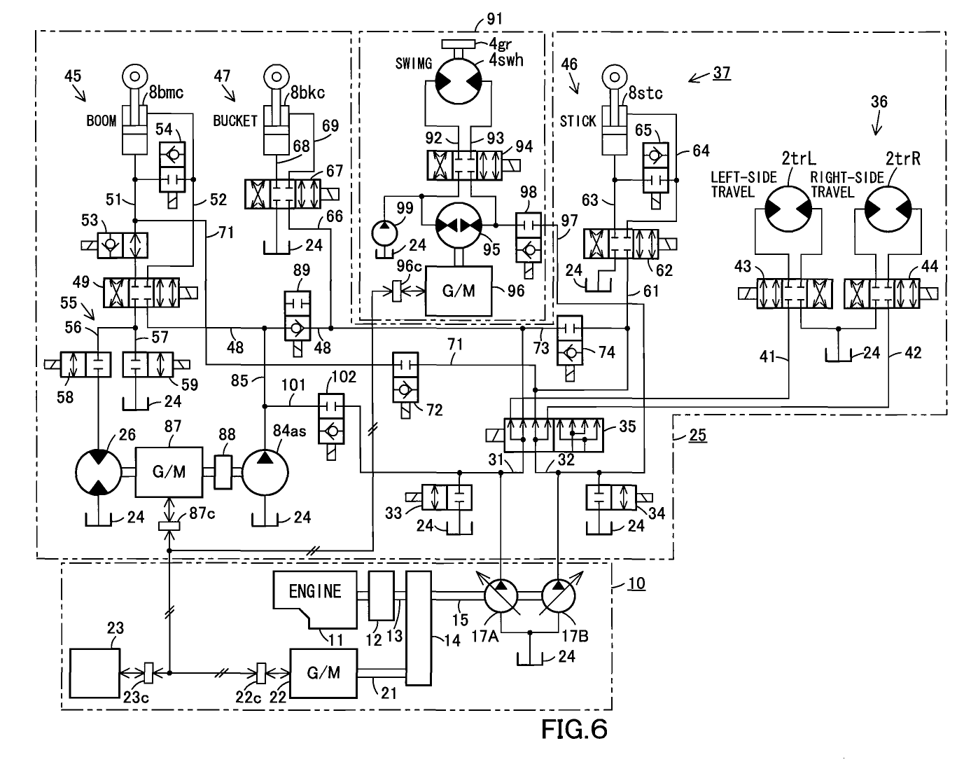

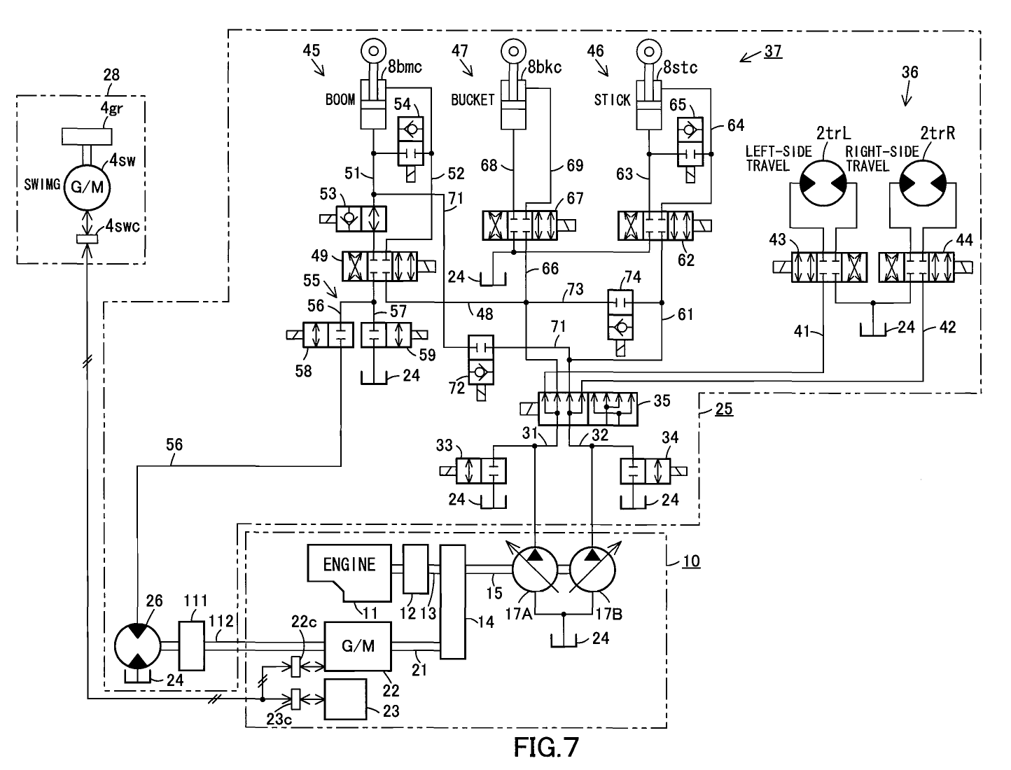

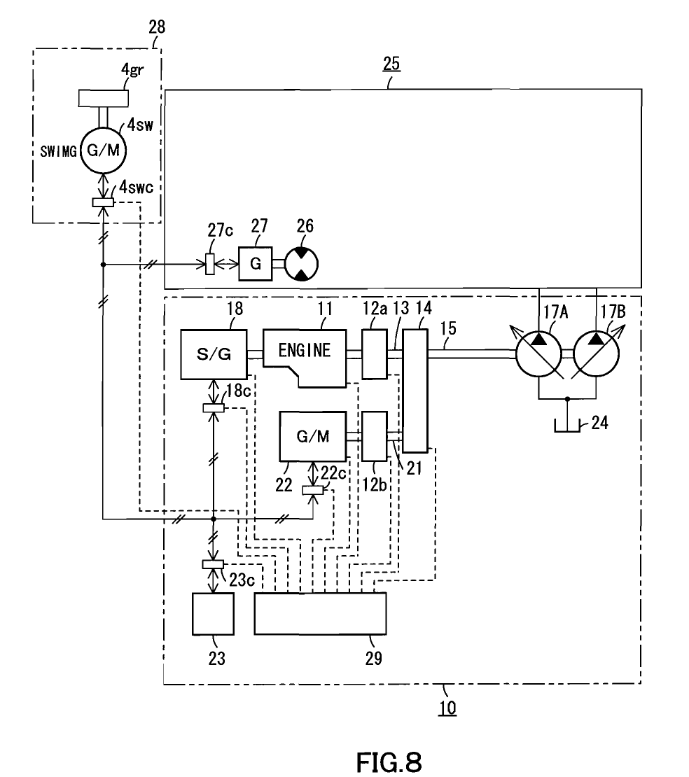

Next, the present invention is explained in detail hereunder, referring to an embodiment thereof shown in FIGS. 1 and 2, another embodiment shown in FIG. 3, a further embodiment shown in FIG. 4, an embodiment shown in FIG. 5, another embodiment shown in FIG. 6, a further embodiment shown in FIG. 7, and a variant of a hybrid drive system shown in FIG. 8.

The embodiment shown in FIGS. 1 and 2 is explained.

As shown in FIG. 2, a work machine 1 is a hydraulic excavator that includes a machine body 7. The machine body 7 is comprised of a lower structure 2, an upper structure 4 rotatably mounted on the lower structure 2 with a swing bearing portion 3 therebetween, and components mounted on the upper structure 4. The components mounted on the upper structure 4 include a power unit 5 comprised of an engine, hydraulic pumps, etc., and a cab 6 for protecting an operator. The lower structure 2 is provided with travel motors 2trL,2trR for respectively driving right and left crawler belts. The upper structure 4 is provided with a swing motor generator (not shown in FIG. 2) for driving a swing deceleration mechanism provided in the swing bearing portion 3.

A work equipment 8 is attached to the upper structure 4. The work equipment 8 comprises a boom 8bm, a stick 8st, and a bucket 8bk that are connected sequentially as well as pivotally by means of pins, wherein the boom 8bm is attached to a bracket (not shown) of the upper structure 4 by means of pins. The boom 8bm, the stick 8st, and the bucket 8bk can be respectively pivoted by means of a boom cylinder 8bmc, a stick cylinder 8stc, and a bucket cylinder 8bkc, each of which serves as a hydraulic actuator.

A hybrid drive system 10 shown in FIG. 1 comprises an engine 11, a clutch 12, a power transmission unit 14, and two main pumps 17A,17B of a variable delivery type. In the explanation hereunder, the main pumps 17A,17B may also be referred to as the first main pump and the second main pump, respectively. The clutch 12 is connected to the engine 11 and serves to enable or interrupt transmission of rotational power output from the engine 11. An input axis 13 of the power transmission unit 14 is connected to the clutch 12, and the main pumps 17A,17B are connected to an output axis 15 of the power transmission unit 14.

A motor generator 22 is connected to an input/output axis 21 of the power transmission unit 14 so that the motor generator 22 is arranged in parallel with the engine 11 with respect to the main pumps 17A,17B. The motor generator 22 is adapted to be driven by the engine 11 so as to function as a generator as well as receive electric power so as to function as an electric motor. The motor power of the motor generator 22 is set to be smaller than the engine power. A motor generator controller 22c, which may be an inverter or the like, is connected to the motor generator 22.

The motor generator controller 22c is connected to an electric power storage device 23, which may be a battery, a capacitor, or the like, through an electric power storage device controller 23c, which may be a converter or the like. The electric power storage device 23 serves to store electric power fed from the motor generator 22 functioning as a generator, as well as feed electric power to the motor generator 22 functioning as a motor.

The power transmission unit 14 of the hybrid drive system 10 incorporates a continuously variable transmission mechanism, such as a toroidal type, a planetary gear type, etc., so that, upon receiving a control signal from outside, the power transmission unit 14 is capable of outputting rotation of continuously varying speed to its output axis 15.

The main pumps 17A,17B of the hybrid drive system 10 serve to feed hydraulic fluid, such as hydraulic oil, that is contained in a tank 24 to a hydraulic actuator control circuit 25. The hydraulic actuator control circuit 25 includes an energy recovery motor 26. The energy recovery motor 26 is adapted to drive a generator 27. The generator 27 is provided with a generator controller 27c so that, when the energy recovery motor 26 drives the generator 27, electric power is recovered from the generator 27 through the generator controller 27c and stored in the electric power storage device 23.

A swing control circuit 28 is provided separately and independently from the hydraulic actuator control circuit 25. The swing control circuit 28 serves to feed electric power from the electric power storage device 23 of the hybrid drive system 10 to the aforementioned swing motor generator, which is represented by 4sw in FIG. 1, so that the swing motor generator 4sw functions as an electric motor. Another function of the swing control circuit 28 is to recover to the electric power storage device 23 electric power generated by the swing motor generator 4sw functioning as a generator during braking of rotating motion of the upper structure 4.

The swing control circuit 28 includes the aforementioned swing motor generator 4sw and a swing motor generator controller 4swc, which may be an inverter or the like. The swing motor generator 4sw serves to rotate the upper structure 4 through a swing deceleration mechanism 4gr. The swing motor generator 4sw is adapted to be driven by electric power fed from the electric power storage device 23 of the hybrid drive system 10 so as to function as an electric motor. The swing motor generator 4sw is also adapted to function as a generator when being rotated by inertial rotation force so as to recover electric power to the electric power storage device 23.

Speed of the engine 11, engagement/disengagement by the clutch 12, and speed change by the power transmission unit 14 are controlled based on signals output from a controller (not shown).

FIG. 1 shows the aforementioned hydraulic actuator control circuit 25, in which main pump passages 31,32 are respectively connected to output ports of the main pumps 17A,17B. The main pump passages 31,32 are also respectively connected to solenoid valves 33,34, which serve as proportional solenoid valves, as well as to a solenoid valve 35, which is adapted to function as a straight travel valve. The solenoid valves 33,34 are respectively disposed in bypass passages for returning hydraulic fluid to the tank 24.

Each solenoid valve 33,34 may function as a bypass valve. To be more specific, when there is no operating signal that signifies the operator operating any one of the corresponding hydraulic actuators 2trL,2trR,8bmc,8stc,8bkc, a control signal from the controller controls the valve to a fully open position so that the corresponding main pump passage 31,32 communicates with the tank 24. When the operator operates any hydraulic actuator 2trL,2trR,8bmc,8stc,8bkc, the corresponding solenoid valve 33,34 shifts towards a closed position in proportion to the magnitude of the operating signal.

When at the work position, i.e. the left position as viewed in FIG. 1, the solenoid valve 35 enables hydraulic fluid to be fed from the two main pumps 17A,17B to the hydraulic actuators 2trL,2trR,8bmc,8stc,8bkc. When the solenoid valve 35 is switched to the right position, i.e. the straight travel position, it permits one of the main pumps, i.e. the main pump 17B, to feed equally divided volume of hydraulic fluid to the two travel motors 2trL,2trR, thereby enabling the work machine 1 to travel straight.

The hydraulic actuator control circuit 25 includes a travel control circuit 36 and a work equipment control circuit 37. The travel control circuit 36 serves to control hydraulic fluid fed from the main pumps 17A,17B of the hybrid drive system 10 to the travel motors 2trL,2trR. The work equipment control circuit 37 serves to control hydraulic fluid fed from the main pumps 17A,17B of the hybrid drive system 10 to the work actuators 8bmc,8stc,8bkc, which serve to operate the work equipment 8.

The travel control circuit 36 includes solenoid valves 43,44 for controlling direction and flow rate of hydraulic fluid supplied respectively through travel motor hydraulic fluid feeding passages 41,42. The travel motor hydraulic fluid feeding passages 41,42 are drawn from the solenoid valve 35, which functions as a straight travel valve.

The work equipment control circuit 37 includes a boom control circuit 45, a stick control circuit 46, and a bucket control circuit 47. The boom control circuit 45 serves to control hydraulic fluid fed from the main pumps 17A,17B of the hybrid drive system 10 to the boom cylinder 8bmc. The stick control circuit 46 serves to control hydraulic fluid fed from the main pumps 17A,17B of the hybrid drive system 10 to the stick cylinder 8stc. The bucket control circuit 47 serves to control hydraulic fluid fed from the main pumps 17A,17B of the hybrid drive system 10 to the bucket cylinder 8bkc.

The boom control circuit 45 includes a solenoid valve 49 for controlling direction and flow rate of hydraulic fluid received through a boom cylinder hydraulic fluid feeding passage 48. The boom cylinder hydraulic fluid feeding passage 48 is drawn from the solenoid valve 35, which functions as a straight travel valve. The solenoid valve 49 is provided with hydraulic fluid feed/discharge passages 51,52, which respectively communicate with the head-side chamber and the rod-side chamber of the boom cylinder 8bmc.

A solenoid valve 53 that serves as a fall preventive valve is disposed in the head-side hydraulic fluid feed/discharge passage 51 so that when movement of the boom 8bm is stopped, the boom 8bm is prevented from descending due to its own weight by switching the solenoid valve 53 to a check valve position at the left side, at which the solenoid valve 53 functions as a check valve. A solenoid valve 54 that serves as a regeneration valve is disposed between the two hydraulic fluid feed/discharge passages 51,52 so that a part of the return fluid discharged from the head-side chamber of the boom cylinder 8bmc can be regenerated into the rod-side chamber by switching the solenoid valve 54 to the check valve position when the boom is lowered.

A return fluid passage 55 to which the fluid discharged from the boom cylinder 8bmc is branched is provided at the tank passage side of the solenoid valve 49. The return fluid passage 55 comprises two return passages 56,57, which are provided with a flow rate ratio control valve 58,59 for controlling a ratio of fluid that branches off into the return passages 56,57. The flow rate ratio control valve 58,59 is comprised of two flow control solenoid valves: a solenoid valve 58 disposed in the return passage 56, which is provided with the aforementioned energy recovery motor 26, and a solenoid valve 59 disposed in the return passage 57, which branches off the upstream side of the solenoid valve 58.

When the energy recovery motor 26 is in operation, its rotation speed is controlled by the flow rate of return fluid in the return passage 56, the aforementioned flow rate being controlled by the flow rate ratio control valve 58,59. This energy recovery motor 26 drives the generator 27 so that electric power is fed from the generator 27 to the electric power storage device 23 of the hybrid drive system 10 and stored therein.

It is desirable for the energy recovery motor 26 to function when the solenoid valve 49, which is provided for controlling direction and flow rate of hydraulic fluid, is positioned at the right chamber position as viewed in FIG. 1. In other words, it is desirable that when the boom is lowered, the hydraulic fluid feed/discharge passage 51 at the head-side of the boom cylinder 8bmc communicate with the return fluid passage 55 so as to permit the return fluid discharged from the head-side of the boom cylinder 8bmc to drive the energy recovery motor 26 well within its capacity because of the dead weight of the boom.

The stick control circuit 46 includes a solenoid valve 62 for controlling direction and flow rate of hydraulic fluid received through a stick cylinder hydraulic fluid feeding passage 61. The stick cylinder hydraulic fluid feeding passage 61 is drawn from the solenoid valve 35, which functions as a straight travel valve. The solenoid valve 62 is provided with hydraulic fluid feed/discharge passages 63,64, which respectively communicate with the head-side chamber and the rod-side chamber of the stick cylinder 8stc. A solenoid valve 65 that serves as a regeneration valve for returning fluid from the rod side to the head side is disposed between the two hydraulic fluid feed/discharge passages 63,64 so that the return fluid discharged from the rod-side chamber of the stick cylinder 8stc can be regenerated into the head-side chamber by switching the solenoid valve 65 to the check valve position when the stick is lowered by stick-in operation.

The bucket control circuit 47 includes a solenoid valve 67 for controlling direction and flow rate of hydraulic fluid received through a bucket cylinder hydraulic fluid feeding passage 66. The bucket cylinder hydraulic fluid feeding passage 66 is drawn from the solenoid valve 35, which functions as a straight travel valve. The solenoid valve 67 is provided with hydraulic fluid feed/discharge passages 68,69, which respectively communicate with the head-side chamber and the rod-side chamber of the bucket cylinder 8bkc.

A circuit-to-circuit communicating passage 71 between stick and boom is disposed between the stick cylinder hydraulic fluid feeding passage 61 and the head-side of the boom cylinder 8bmc and thereby provides fluid communication between them. A solenoid valve 72 between stick and boom is disposed in the circuit-to-circuit communicating passage 71 between stick and boom. The solenoid valve 72 between stick and boom is adapted to shift between a position for enabling flow in a one-way direction from the stick cylinder hydraulic fluid feeding passage 61 to the head-side of the boom cylinder 8bmc and a position for interrupting the flow of fluid.

A circuit-to-circuit communicating passage 73 between boom and stick is disposed between the boom cylinder hydraulic fluid feeding passage 48 and the stick cylinder hydraulic fluid feeding passage 61 and thereby provides fluid communication between them. A solenoid valve 74 between boom and stick is disposed in the circuit-to-circuit communicating passage 73 between boom and stick. The solenoid valve 74 between boom and stick is adapted to shift between a position for enabling flow in a one-way direction from the boom cylinder hydraulic fluid feeding passage 48 to the stick cylinder 8stc and a position for interrupting the flow of fluid.

Each one of the solenoid valves 53,54,65,72,74 is a selector valve that incorporates a check valve and is capable of controlling flow rate.

Each one of the solenoid valves 33,34,35,43,44,49,53,54,58,59,62,65,67,72,74 has a return spring (not shown) and a solenoid that is adapted to be proportionally controlled by the aforementioned controller (not shown) so that each solenoid valve is controlled at a position to achieve a balance between excitation force of the solenoid and restorative force of the spring.

Next, the operations and effects of the embodiment shown in FIGS. 1 and 2 are explained hereunder.

The work equipment control circuit 37 drives the energy recovery motor 26 by means of the return fluid discharged from the boom cylinder 8bmc so that the energy recovery motor 26 drives the generator 27 to feed electric power to the electric power storage device 23 of the hybrid drive system 10. Therefore, the work equipment control circuit 37 enables the energy of the return fluid discharged from the boom cylinder 8bmc to be efficiently recovered to the electric power storage device 23 so that the energy can be effectively regenerated as pump power for the hybrid drive system 10.

At the return fluid passage 55 at that time, the work equipment control circuit 37 divides the return fluid discharged from the boom cylinder 8bmc, controls the proportion of divided flows of the fluid by the flow rate ratio control valve 58,59, and, by means of the return fluid in one of the divided flows, whose flow rate is controlled by the flow rate ratio control valve 58,59, drives the energy recovery motor 26. With the configuration as above, the work equipment control circuit 37 is capable of gradually increasing the flow rate proportion of the fluid distributed towards the energy recovery motor 26 side from the moment the return fluid starts to flow from the boom cylinder 8bmc, thereby preventing the occurrence of shock, as well as ensuring stable function of the boom cylinder 8bmc by preventing a sudden change in load to the boom cylinder 8bmc.

In other words, when the boom 8bm of the work equipment 8 descends due to its own weight, gradual increase of the flow rate proportion of the return fluid discharged from the head side of the boom cylinder 8bmc towards the energy recovery motor 26 side enables the energy recovery motor 26 to smoothly absorb the energy of the return fluid and prevent a sudden change in load to the boom cylinder 8bmc, stabilizing the descending action of the boom 8bm due to its own weight. In short, energy generated during descent of the boom can be stored independent of other circuits.

According to the embodiment described above, the solenoid valve 58 and the solenoid valve 59 can be disposed at desired, separate locations in the return passage 56 and the return passage 57 respectively. Furthermore, the present embodiment also enables control of return fluid flowing towards the energy recovery motor 26 at a desired flow rate and flow rate ratio by controlling an aperture of each respective return passage 56,57 separately and independently of each other.

The swing control circuit 28 enables the upper structure 4 to rotate on the lower structure 2 by operating the swing motor generator 4sw to function as an electric motor. When stopping the upper structure 4 during its rotation, the swing control circuit 28 operates the swing motor generator 4sw to function as a generator. Thus, the rotation of the upper structure 4 can be braked, while the electric power generated by the swing motor generator 4sw, together with the electric power generated by the generator 27, which is being driven by the energy recovery motor 26, can be efficiently recovered to the electric power storage device 23 of the hybrid drive system 10 and effectively regenerated as pump power for the hybrid drive system 10.

Furthermore, opening the solenoid valve 74 between boom and stick and closing the solenoid valve 72 between stick and boom enables hydraulic fluid that would otherwise be fed from the first main pump 17A to the boom cylinder 8bmc to merge with the hydraulic fluid fed from the second main pump 17B to the stick cylinder 8stc, thereby increasing the speed of the stick cylinder 8bstc. Closing the solenoid valve 74 between boom and stick and opening the solenoid valve 72 between stick and boom enables the hydraulic fluid that would otherwise be fed from the second main pump 17B to the stick cylinder 8stc to merge with the hydraulic fluid that is discharged from the first main pump 17A and fed through the boom cylinder hydraulic fluid feeding passage 48 and the left chamber of the directional control solenoid valve 49 to the head-side of the boom cylinder 8bmc, speeding up the boom raising action.

Furthermore, controlling the solenoid valve 74 between boom and stick at the flow interruption position enables the boom control circuit 45 and the stick control circuit 46 to function independently of each other, thereby separating the stick system from the boom system and the bucket system so that the pressure in the stick system can be controlled independently of the pressures in the boom system and the bucket system.

Next, the embodiment shown in FIG. 3 is explained. As the work machine that employs this embodiment is the same as the one shown in FIG. 2, its explanation is omitted hereunder.

A hybrid drive system 10 shown in FIG. 3 comprises an engine 11, a clutch 12, a power transmission unit 14, and two main pumps 17A,17B of a variable delivery type. In the explanation hereunder, the main pumps 17A,17B may also be referred to as the first main pump and the second main pump, respectively. The clutch 12 is connected to the engine 11 and serves to transmit or interrupt rotational power output from the engine 11. An input axis 13 of the power transmission unit 14 is connected to the clutch 12, and an output axis 15 of the power transmission unit 14 is connected to the main pumps 17A,17B.

A motor generator 22 is connected to an input/output axis 21 of the power transmission unit 14 so that the motor generator 22 is arranged in parallel with the engine 11 with respect to the main pumps 17A,17B. The motor generator 22 is adapted to be driven by the engine 11 so as to function as a generator as well as receive electric power so as to function as an electric motor. The motor power of the motor generator 22 is set to be smaller than the engine power. A motor generator controller 22c, which may be an inverter or the like, is connected to the motor generator 22.

The motor generator controller 22c is connected to an electric power storage device 23, which may be a battery, a capacitor, or the like, through an electric power storage device controller 23c, which may be a converter or the like. The electric power storage device 23 serves to store electric power fed from the motor generator 22 functioning as a generator, as well as feed electric power to the motor generator 22 functioning as a motor.

The power transmission unit 14 of the hybrid drive system 10 incorporates a continuously variable transmission mechanism, such as a toroidal type, a planetary gear type, etc., so that, upon receiving a control signal from outside, the power transmission unit 14 is capable of outputting rotation of continuously varying speed to its output axis 15.

The main pumps 17A,17B of the hybrid drive system 10 serve to feed hydraulic fluid, such as hydraulic oil, that is contained in a tank 24 to a hydraulic actuator control circuit 25. The hydraulic actuator control circuit 25 includes an energy recovery motor 26. The energy recovery motor 26 is adapted to drive a generator 27. The generator 27 is provided with a generator controller 27c so that, when the energy recovery motor 26 drives the generator 27, electric power is recovered from the generator 27 through the generator controller 27c and stored in the electric power storage device 23.

A swing control circuit 28 is provided separately and independently from the hydraulic actuator control circuit 25. The swing control circuit 28 serves to feed electric power from the electric power storage device 23 of the hybrid drive system 10 to a swing motor generator 4sw so that the swing motor generator 4sw functions as an electric motor. Another function of the swing control circuit 28 is to recover to the electric power storage device 23 electric power generated by the swing motor generator 4sw functioning as a generator during braking of rotating motion of the upper structure 4.

The swing control circuit 28 includes the aforementioned swing motor generator 4sw and a swing motor generator controller 4swc, which may be an inverter or the like. The swing motor generator 4sw serves to rotate the upper structure 4 through a swing deceleration mechanism 4gr. The swing motor generator 4sw is adapted to be driven by electric power fed from the electric power storage device 23 of the hybrid drive system 10 so as to function as an electric motor. The swing motor generator 4sw is also adapted to function as a generator when being rotated by inertial rotation force so that electric power is recovered to the electric power storage device 23 and can be used to drive the electric motor.

Speed of the engine 11, engagement/disengagement by the clutch 12, and speed change by the power transmission unit 14 are controlled based on signals output from a controller (not shown).

The hydraulic actuator control circuit 25 shown in FIG. 3 includes pump passages 31,32, which are respectively connected to output ports of the main pumps 17A,17B. The pump passages 31,32 are also respectively connected to solenoid valves 33,34, which serve as proportional solenoid valves, as well as to a solenoid valve 35, which is adapted to function as a straight travel valve. The solenoid valves 33,34 are respectively disposed in bypass passages for returning hydraulic fluid to the tank 24.

Each solenoid valve 33,34 may function as a bypass valve. To be more specific, when there is no operating signal that signifies the operator operating any one of the corresponding hydraulic actuators 2trL,2trR,8bmc,8stc,8bkc, a control signal from the controller controls the valve to a fully open position so that the corresponding main pump passage 31,32 communicates with the tank 24. When the operator operates any hydraulic actuator 2trL,2trR,8bmc,8stc,8bkc, the corresponding solenoid valve 33,34 shifts towards a closed position in proportion to the magnitude of the operating signal.

When at the work position, i.e. the left position as viewed in FIG. 3, the solenoid valve 35 enables hydraulic fluid to be fed from the two main pumps 17A,17B to the hydraulic actuators 2trL,2trR,8bmc,8stc,8bkc. When the solenoid valve 35 is switched to the right position, i.e. the straight travel position, it permits one of the main pumps, i.e. the main pump 17B, to feed equally divided volume of hydraulic fluid to the two travel motors 2trL,2trR, thereby enabling the work machine 1 to travel straight.

The hydraulic actuator control circuit 25 includes a travel control circuit 36 and a work equipment control circuit 37. The travel control circuit 36 serves to control hydraulic fluid fed from the main pumps 17A,17B of the hybrid drive system 10 to the travel motors 2trL,2trR. The work equipment control circuit 37 serves to control hydraulic fluid fed from the main pumps 17A,17B of the hybrid drive system 10 to the work actuators 8bmc,8stc,8bkc, which serve to operate the work equipment 8.

The travel control circuit 36 includes solenoid valves 43,44 for controlling direction and flow rate of hydraulic fluid supplied respectively through travel motor hydraulic fluid feeding passages 41,42. The travel motor hydraulic fluid feeding passages 41,42 are drawn from the solenoid valve 35, which functions as a straight travel valve.

The work equipment control circuit 37 includes a boom control circuit 45, a stick control circuit 46, and a bucket control circuit 47. The boom control circuit 45 serves to control hydraulic fluid fed from the main pumps 17A,17B of the hybrid drive system 10 to the boom cylinder 8bmc. The stick control circuit 46 serves to control hydraulic fluid fed from the main pumps 17A,17B of the hybrid drive system 10 to the stick cylinder 8stc. The bucket control circuit 47 serves to drive a bucket pump 82 and control hydraulic fluid fed from the bucket pump 82 to the bucket cylinder 8bkc. The bucket control circuit 47 drives the bucket pump 82 by means of a bucket motor 81, which is adapted to be run by electric power supplied from the electric power storage device 23 of the hybrid drive system 10. Rotation speed of the bucket motor 81 is controlled by a bucket motor controller 81c, which may be an inverter or the like. The bucket motor controller 81c is connected to the aforementioned controller, which is not shown in the drawing.

The boom control circuit 45 includes a solenoid valve 49 for controlling direction and flow rate of hydraulic fluid received through a boom cylinder hydraulic fluid feeding passage 48. The boom cylinder hydraulic fluid feeding passage 48 is drawn from the solenoid valve 35, which functions as a straight travel valve. The solenoid valve 49 is provided with hydraulic fluid feed/discharge passages 51,52, which respectively communicate with the head-side chamber and the rod-side chamber of the boom cylinder 8bmc.

A solenoid valve 53 that serves as a fall preventive valve is disposed in the head-side hydraulic fluid feed/discharge passage 51 so that when movement of the boom 8bm is stopped, the boom 8bm is prevented from descending due to its own weight by switching the solenoid valve 53 to a check valve position at the left side, at which the solenoid valve 53 functions as a check valve. A solenoid valve 54 that serves as a regeneration valve is disposed between the two hydraulic fluid feed/discharge passages 51,52 so that a part of the return fluid discharged from the head-side chamber of the boom cylinder 8bmc can be regenerated into the rod-side chamber by switching the solenoid valve 54 to the check valve position when the boom is lowered.

A return fluid passage 55 to which the fluid discharged from the boom cylinder 8bmc is branched is provided at the tank passage side of the solenoid valve 49. The return fluid passage 55 comprises two return passages 56,57, which are provided with a flow rate ratio control valve 58,59 for controlling a ratio of fluid that branches off into the return passages 56,57. The flow rate ratio control valve 58,59 is comprised of two flow control solenoid valves: a solenoid valve 58 disposed in the return passage 56, which is provided with the aforementioned energy recovery motor 26, and a solenoid valve 59 disposed in the return passage 57, which branches off the upstream side of the solenoid valve 58.

When the energy recovery motor 26 is in operation, its rotation speed is controlled by the flow rate of return fluid in the return passage 56, the aforementioned flow rate being controlled by the flow rate ratio control valve 58,59. This energy recovery motor 26 drives the generator 27 so that electric power is fed from the generator 27 to the electric power storage device 23 of the hybrid drive system 10 and stored therein.

It is desirable for the energy recovery motor 26 to function when the solenoid valve 49, which is provided for controlling direction and flow rate of hydraulic fluid, is positioned at the right chamber position as viewed in FIG. 3. In other words, it is desirable that when the boom is lowered, the hydraulic fluid feed/discharge passage 51 at the head-side of the boom cylinder 8bmc communicate with the return fluid passage 55 so as to permit the return fluid discharged from the head-side of the boom cylinder 8bmc to drive the energy recovery motor 26 well within its capacity because of the dead weight of the boom.

The stick control circuit 46 includes a solenoid valve 62 for controlling direction and flow rate of hydraulic fluid received through a stick cylinder hydraulic fluid feeding passage 61. The stick cylinder hydraulic fluid feeding passage 61 is drawn from the solenoid valve 35, which functions as a straight travel valve. The solenoid valve 62 is provided with hydraulic fluid feed/discharge passages 63,64, which respectively communicate with the head-side chamber and the rod-side chamber of the stick cylinder 8stc. A solenoid valve 65 that serves as a regeneration valve for returning fluid from the rod side to the head side is disposed between the two hydraulic fluid feed/discharge passages 63,64 so that the return fluid discharged from the rod-side chamber of the stick cylinder 8stc can be regenerated into the head-side chamber by switching the solenoid valve 65 to the check valve position when the stick is lowered by stick-in operation.

The bucket control circuit 47 serves to drive the bucket pump 82 by means of the bucket motor 81, which is adapted to be run by electric power supplied from the electric power storage device 23 of the hybrid drive system 10. The bucket control circuit 47 includes a solenoid valve 67 for controlling direction and flow rate of hydraulic fluid supplied from the bucket pump 82. The solenoid valve 67 is provided with hydraulic fluid feed/discharge passages 68,69, which respectively communicate with the head-side chamber and the rod-side chamber of the bucket cylinder 8bkc.

A circuit-to-circuit communicating passage 73 between boom and stick is disposed between the boom cylinder hydraulic fluid feeding passage 48 and the stick cylinder hydraulic fluid feeding passage 61 and thereby provides fluid communication between them. A solenoid valve 83 between boom and stick is disposed in the circuit-to-circuit communicating passage 73 between boom and stick. The solenoid valve 83 between boom and stick is adapted to shift between a position for enabling flow in a one-way direction from the boom cylinder hydraulic fluid feeding passage 48 to the stick cylinder hydraulic fluid feeding passage 61; a position for enabling flow in both directions; and a neutral position for interrupting the flow of fluid.

Each one of the solenoid valves 53,54,65,83 is a selector valve that incorporates a check valve and is capable of controlling flow rate.

Each one of the solenoid valves 33,34,35,43,44,49,53,54,58,59,62,65,67,83 has a return spring (not shown) and a solenoid that is adapted to be proportionally controlled by the aforementioned controller (not shown) so that each solenoid valve is controlled at a position to achieve a balance between excitation force of the solenoid and restorative force of the spring.

Next, the operations and effects of the embodiment shown in FIG. 3 are explained hereunder.

As described above, the bucket control circuit 47 serves to drive the bucket pump 82 by means of the bucket motor 81, which is adapted to be run by electric power supplied from the electric power storage device 23 of the hybrid drive system 10, and also to control hydraulic fluid supplied from the bucket pump 82 to the bucket cylinder 8bkc. The bucket control circuit 47 is adapted to function independently of the travel control circuit 36, the boom control circuit 45 and the stick control circuit 46, which are supplied with hydraulic fluid from the main pumps 17A,17B of the hybrid drive system 10. Therefore, the high pressure required by the bucket control circuit 47 is ensured without being affected by the travel control circuit 36, the boom control circuit 45, or the stick control circuit 46.

At that time, by controlling rotation speed of the bucket motor 81 by means of the aforementioned controller (not shown), the pump discharge rate of the bucket pump 82 is variably controlled. Direction of hydraulic fluid supplied from the bucket pump 82 to the bucket cylinder 8bkc is controlled by the solenoid valve 67, which functions based on signals output from the controller (not shown).

At the return fluid passage 55, the boom control circuit 45 divides the return fluid discharged from the boom cylinder 8bmc, controls the proportion of divided flows of the fluid by the flow rate ratio control valve 58,59, and, by means of the return fluid in one of the divided flows, whose flow rate is controlled by the flow rate ratio control valve 58,59, drives the energy recovery motor 26 so that the energy recovery motor 26 drives the generator 27 to feed electric power to the electric power storage device 23 of the hybrid drive system 10. With the configuration as above, the boom control circuit 45 is capable of gradually increasing the flow rate proportion of the fluid distributed towards the energy recovery motor 26 side from the moment the return fluid starts to flow from the boom cylinder 8bmc, thereby preventing the occurrence of shock, as well as ensuring stable function of the boom cylinder 8bmc by preventing a sudden change in load to the boom cylinder 8bmc.

In other words, when the boom 8bm of the work equipment 8 descends due to its own weight, gradual increase of the flow rate proportion of the return fluid discharged from the head side of the boom cylinder 8bmc towards the energy recovery motor 26 side enables the energy recovery motor 26 to smoothly absorb the energy of the return fluid and prevent a sudden change in load to the boom cylinder 8bmc, stabilizing the descending action of the boom 8bm due to its own weight.

According to the embodiment described above, the solenoid valve 58 and the solenoid valve 59 can be disposed at desired, separate locations in the return passage 56 and the return passage 57 respectively. Furthermore, the present embodiment also enables control of return fluid flowing towards the energy recovery motor 26 side at a desired flow rate and flow rate ratio by controlling an aperture of each respective return passage 56,57 separately and independently of each other.

The swing control circuit 28 enables the upper structure 4 to rotate on the lower structure 2 by operating the swing motor generator 4sw to function as an electric motor. When stopping the upper structure 4 during its rotation, the swing control circuit 28 operates the swing motor generator 4sw to function as a generator. Thus, the rotation of the upper structure 4 can be braked, while the electric power generated by the swing motor generator 4sw, together with the electric power generated by the generator 27, which is being driven by the energy recovery motor 26, can be efficiently recovered to the electric power storage device 23 of the hybrid drive system 10 and effectively regenerated as pump power for the hybrid drive system 10, resulting in improved fuel efficiency of the engine 11 of the hybrid drive system 10.

Furthermore, controlling the solenoid valve 83, which is disposed in the circuit-to-circuit communicating passage 73 between boom and stick, at the aforementioned position for enabling flow in a one-way direction or the position for enabling flow in both directions allows supply of hydraulic fluid from the boom control circuit 45 to the stick control circuit 46. In other words, thus controlling the solenoid valve 83 enables hydraulic fluid that would otherwise be fed from the first main pump 17A to the boom cylinder 8bmc to merge with the hydraulic fluid fed from the second main pump 17B to the stick cylinder 8stc, thereby increasing the speed of the stick cylinder 8stc.

Controlling the solenoid valve 83 between boom and stick at the position for enabling flow in both directions also allows hydraulic fluid to be fed from the stick control circuit 46 to the boom control circuit 45. In other words, thus controlling the solenoid valve 83 enables hydraulic fluid that would otherwise be fed from the second main pump 17B to the stick cylinder 8stc to merge with the hydraulic fluid that is discharged from the first main pump 17A and fed through the boom cylinder hydraulic fluid feeding passage 48 and the left chamber of the solenoid valve 49 to the head-side of the boom cylinder 8bmc, speeding up the boom raising action by thus combining hydraulic fluid from the two main pumps.

Furthermore, controlling the solenoid valve 83 between boom and stick at the neutral position enables the boom control circuit 45 and the stick control circuit 46 to function independently of each other, thereby separating the boom system and the stick system so that pressures in the two systems can be controlled independently of each other.

Next, the embodiment shown in FIG. 4 is explained. As the work machine that employs this embodiment is the same as the one shown in FIG. 2, its explanation is omitted hereunder.

A hybrid drive system 10 shown in FIG. 4 comprises an engine 11, a clutch 12, a power transmission unit 14, and two main pumps 17A,17B of a variable delivery type. In the explanation hereunder, the main pumps 17A,17B may also be referred to as the first main pump and the second main pump, respectively. The clutch 12 is connected to the engine 11 and serves to transmit or interrupt rotational power output from the engine 11. An input axis 13 of the power transmission unit 14 is connected to the clutch 12, and an output axis 15 of the power transmission unit 14 is connected to the main pumps 17A,17B.

A motor generator 22 is connected to an input/output axis 21 of the power transmission unit 14 so that the motor generator 22 is arranged in parallel with the engine 11 with respect to the main pumps 17A,17B. The motor generator 22 is adapted to be driven by the engine 11 so as to function as a generator as well as receive electric power so as to function as an electric motor. The motor power of the motor generator 22 is set to be smaller than the engine power. A motor generator controller 22c, which may be an inverter or the like, is connected to the motor generator 22.

The motor generator controller 22c is connected to an electric power storage device 23, which may be a battery, a capacitor, or the like, through an electric power storage device controller 23c, which may be a converter or the like. The electric power storage device 23 serves to store electric power fed from the motor generator 22 functioning as a generator, as well as feed electric power to the motor generator 22 functioning as a motor.

The power transmission unit 14 of the hybrid drive system 10 incorporates a continuously variable transmission mechanism, such as a toroidal type, a planetary gear type, etc., so that, upon receiving a control signal from outside, the power transmission unit 14 is capable of outputting rotation of continuously varying speed to its output axis 15.

The main pumps 17A,17B of the hybrid drive system 10 serve to feed hydraulic fluid, such as hydraulic oil, that is contained in a tank 24 to a hydraulic actuator control circuit 25. The hydraulic actuator control circuit 25 serves to control hydraulic fluid fed to the travel motors 2trL,2trR, the stick cylinder 8stc, and the bucket cylinder 8bkc.

A boom control circuit 45 for controlling hydraulic fluid fed to the boom cylinder 8bmc is provided separately and independently from the hydraulic actuator control circuit 25.

A swing control circuit 28 is provided separately and independently from the hydraulic actuator control circuit 25 and the boom control circuit 45. The swing control circuit 28 serves to feed electric power from the electric power storage device 23 of the hybrid drive system 10 to a swing motor generator 4sw so that the swing motor generator 4sw functions as an electric motor. Another function of the swing control circuit 28 is to recover to the electric power storage device 23 electric power generated by the swing motor generator 4sw functioning as a generator during braking of rotating motion of the upper structure 4.

The swing control circuit 28 includes the aforementioned swing motor generator 4sw and a swing motor generator controller 4swc, which may be an inverter or the like. The swing motor generator 4sw serves to rotate the upper structure 4 through a swing deceleration mechanism 4gr. The swing motor generator 4sw is adapted to be driven by electric power fed from the electric power storage device 23 of the hybrid drive system 10 so as to function as an electric motor. The swing motor generator 4sw is also adapted to function as a generator when being rotated by inertial rotation force so as to recover electric power to the electric power storage device 23.

Main pump passages 31,32 are respectively connected to output ports of the main pumps 17A,17B of the hybrid drive system 10. The main pump passages 31,32 are also respectively connected to solenoid valves 33,34, which serve as proportional solenoid valves, as well as to a solenoid valve 35, which is adapted to function as a straight travel valve. The solenoid valves 33,34 are respectively disposed in bypass passages for returning hydraulic fluid to the tank 24.

Each solenoid valve 33,34 may function as a bypass valve. To be more specific, when there is no operating signal that signifies the operator operating any one of the corresponding hydraulic actuators 2trL,2trR,8stc,8bkc, a control signal from the controller controls the valve to a fully open position so that the corresponding main pump passage 31,32 communicates with the tank 24. When the operator operates any hydraulic actuator 2trL,2trR,8stc,8bkc, the corresponding solenoid valve 33,34 shifts towards a closed position in proportion to the magnitude of the operating signal.

When at the work position, i.e. the left position as viewed in FIG. 4, the solenoid valve 35 enables hydraulic fluid to be fed from the two main pumps 17A,17B to the hydraulic actuators 2trL,2trR,8stc,8bkc. When the solenoid valve 35 is switched to the right position, i.e. the straight travel position, it permits one of the main pumps, i.e. the main pump 17B, to feed equally divided volume of hydraulic fluid to the two travel motors 2trL,2trR, thereby enabling the work machine 1 to travel straight.

The hydraulic actuator control circuit 25 includes a travel control circuit 36, a stick control circuit 46, and a bucket control circuit 47. The travel control circuit 36 serves to control hydraulic fluid fed from the main pumps 17A,17B of the hybrid drive system 10 to the travel motors 2trL,2trR. The stick control circuit 46 serves to control hydraulic fluid fed from the main pumps 17A,17B of the hybrid drive system 10 to the stick cylinder 8stc, which serves to operate the work equipment 8. The bucket control circuit 47 serves to control hydraulic fluid fed from the main pumps 17A,17B of the hybrid drive system 10 to the bucket cylinder 8bkc.

The travel control circuit 36 includes solenoid valves 43,44 for controlling direction and flow rate of hydraulic fluid supplied respectively through travel motor hydraulic fluid feeding passages 41,42. The travel motor hydraulic fluid feeding passages 41,42 are drawn from the solenoid valve 35, which functions as a straight travel valve.

The boom control circuit 45 includes a boom pump 48p and a solenoid valve 49. The boom pump 48p is provided separately from the main pumps 17A,17B of the hybrid drive system 10. The solenoid valve 49 serves to control direction and flow rate of hydraulic fluid fed from the boom pump 48p through a boom cylinder hydraulic fluid feeding passage 48a to the boom cylinder 8bmc. The solenoid valve 49 is provided with hydraulic fluid feed/discharge passages 51,52, which respectively communicate with the head-side chamber and the rod-side chamber of the boom cylinder 8bmc. A solenoid valve 48b that functions in a similar manner to the aforementioned solenoid valves 33,34 is disposed in a bypass passage for returning hydraulic fluid from the boom cylinder hydraulic fluid feeding passage 48a to the tank 24.

A solenoid valve 53 that serves as a fall preventive valve is disposed in the head-side hydraulic fluid feed/discharge passage 51 so that when movement of the boom 8bm is stopped, the boom 8bm is prevented from descending due to its own weight by switching the solenoid valve 53 to a check valve position at the left side, at which the solenoid valve 53 functions as a check valve. A solenoid valve 54 that serves as a regeneration valve is disposed between the two hydraulic fluid feed/discharge passages 51,52 so that a part of the return fluid discharged from the head-side chamber of the boom cylinder 8bmc can be regenerated into the rod-side chamber by switching the solenoid valve 54 to the check valve position when the boom is lowered.

A return fluid passage 55 to which the fluid discharged from the boom cylinder 8bmc is branched is provided at the tank passage side of the solenoid valve 49. The return fluid passage 55 comprises two return passages 56,57, which are provided with a flow rate ratio control valve 58,59 for controlling a ratio of fluid that branches off into the return passages 56,57. The flow rate ratio control valve 58,59 is comprised of two flow control solenoid valves: a solenoid valve 58 disposed in the return passage 56, which is provided with the aforementioned energy recovery motor 26, and a solenoid valve 59 disposed in the return passage 57, which branches off the upstream side of the solenoid valve 58.

An energy recovery motor 86 is provided in the return passage 56, through which return fluid discharged from the boom cylinder 8bmc flows. A boom motor generator 87 is connected to the energy recovery motor 86. The boom motor generator 87 is adapted to be driven by the energy recovery motor 86 so as to function as a generator for feeding electric power to the electric power storage device 23 of the hybrid drive system 10 as well as driven by electric power fed from the electric power storage device 23 so as to function as an electric motor. The aforementioned boom pump 48p is connected to the boom motor generator 87 through a clutch 88. When the boom motor generator 87 functions as an electric motor, the clutch 88 is controlled so as to transmit electric power from the boom motor generator 87 to the boom pump 48p. When the boom motor generator 87 functions as a generator, the clutch 88 is controlled so as to disengage the boom motor generator 87 from the boom pump 48p.

When the energy recovery motor 86 is in operation, its rotation speed is controlled by the flow rate of return fluid in the return passage 56, the aforementioned flow rate being controlled by the flow rate ratio control valve 58,59. By means of a motor generator controller 87c of the boom motor generator 87, electric power is recovered from the boom motor generator 87, which is driven by the energy recovery motor 86, and fed to the electric power storage device 23 of the hybrid drive system 10 and stored therein.

It is desirable for the energy recovery motor 86 to function when the solenoid valve 49, which is provided for controlling direction and flow rate of hydraulic fluid, is positioned at the right chamber position as viewed in FIG. 4. In other words, it is desirable that when the boom is lowered, the hydraulic fluid feed/discharge passage 51 at the head-side of the boom cylinder 8bmc communicate with the return fluid passage 55 so as to permit the return fluid discharged from the head-side of the boom cylinder 8bmc to drive the energy recovery motor 86 well within its capacity because of the dead weight of the boom.

The stick control circuit 46 includes a solenoid valve 62 for controlling direction and flow rate of hydraulic fluid received through a stick cylinder hydraulic fluid feeding passage 61. The stick cylinder hydraulic fluid feeding passage 61 is drawn from the solenoid valve 35, which functions as a straight travel valve. The solenoid valve 62 is provided with hydraulic fluid feed/discharge passages 63,64, which respectively communicate with the head-side chamber and the rod-side chamber of the stick cylinder 8stc. A solenoid valve 65 that serves as a regeneration valve for returning fluid from the rod side to the head side is disposed between the two hydraulic fluid feed/discharge passages 63,64 so that the return fluid discharged from the rod-side chamber of the stick cylinder 8stc can be regenerated into the head-side chamber by switching the solenoid valve 65 to the check valve position when the stick is lowered by stick-in operation.

The bucket control circuit 47 includes a solenoid valve 67 for controlling direction and flow rate of hydraulic fluid received through a bucket cylinder hydraulic fluid feeding passage 66. The bucket cylinder hydraulic fluid feeding passage 66 is drawn from the solenoid valve 35, which functions as a straight travel valve. The solenoid valve 67 is provided with hydraulic fluid feed/discharge passages 68,69, which respectively communicate with the head-side chamber and the rod-side chamber of the bucket cylinder 8bkc.

A circuit-to-circuit communicating passage 73 between bucket and stick is disposed between the bucket cylinder hydraulic fluid feeding passage 66 and the stick cylinder hydraulic fluid feeding passage 61 and thereby provides fluid communication between them. A solenoid valve 74 between bucket and stick is disposed in the circuit-to-circuit communicating passage 73 between bucket and stick. The solenoid valve 74 between bucket and stick is adapted to shift between a position for enabling flow in a one-way direction from the bucket cylinder hydraulic fluid feeding passage 66 to the stick cylinder hydraulic fluid feeding passage 61 and a position for interrupting the flow of fluid.

Speed of the engine 11, engagement/disengagement by the clutch 12, speed change by the power transmission unit 14, and engagement/disengagement by the clutch 88 are controlled based on signals output from a controller (not shown).

Each one of the solenoid valves 53,54,65,74 is a selector valve that incorporates a check valve and is capable of controlling flow rate.

Each one of the solenoid valves 33,34,35,43,44,48b,49,53,54,58,59,62,65,67,74 has a return spring (not shown) and a solenoid that is adapted to be proportionally controlled by the aforementioned controller (not shown) so that each solenoid valve is controlled at a position to achieve a balance between excitation force of the solenoid and restorative force of the spring.

Next, the functions and effects of the embodiment shown in FIG. 4 are explained hereunder.

The boom control circuit 45, which includes the boom pump 48p provided separately from the main pumps 17A,17B of the hybrid drive system 10 and serves to control hydraulic fluid fed from the boom pump 48p to the boom cylinder 8bmc, is adapted to function independently of the hydraulic actuator control circuit 25, which serves to control hydraulic fluid fed from the main pumps 17A,17B of the hybrid drive system 10 to the travel motors 2trL,2trR, the stick cylinder 8stc, and the bucket cylinder 8bkc. Therefore, the flow rate required by the boom cylinder 8bmc can be easily ensured by, for example, controlling the rotation speed of the boom pump 48p by means of the boom motor generator 87 without being affected by the hydraulic fluid fed to the travel motors 2trL,2trR, the stick cylinder 8stc, or the bucket cylinder 8bkc.

The boom control circuit 45 drives the energy recovery motor 86 by means of the return fluid discharged from the boom cylinder 8bmc so that the energy recovery motor 86 drives the boom motor generator 87 to feed electric power to the electric power storage device 23 of the hybrid drive system 10. Therefore, the boom control circuit 45 enables the energy of the return fluid discharged from the boom cylinder 8bmc to be efficiently recovered to the electric power storage device 23 so that the energy can be effectively regenerated as pump power for the hybrid drive system 10.

The configuration described above is particularly beneficial when the boom 8bm of the work equipment 8, which is attached to the machine body 7 of the work machine 1, descends due to its own weight, because the energy of the return fluid discharged from the head side of the boom cylinder 8bmc is absorbed by the energy recovery motor 86 and the boom motor generator 87 and stored in the electric power storage device 23.

At that time, the boom control circuit 45 disengages the clutch 88. As a result, the energy recovery motor 86, which is being driven by the return fluid discharged from the boom cylinder 8bmc, efficiently inputs driving power to the boom motor generator 87, which is under no-load condition, so that the generated electric power is stored in the electric power storage device 23 of the hybrid drive system 10.

When the clutch 88 is engaged, electric power fed from the electric power storage device 23 enables the boom motor generator 87 to function as an electric motor to drive the boom pump 48p so that hydraulic fluid is fed from the boom pump 48p to the boom cylinder 8bmc. Thus, energy of the return fluid discharged from the boom cylinder 8bmc can be effectively recovered even in an open circuit.

The flow rate of the hydraulic fluid fed to the boom cylinder 8bmc at that time is determined by the pump capacity and rotation speed of the boom pump 48p, which is dedicated to the boom circuit. The pump capacity of the boom pump 48p depends on the main pumps 17A,17B, whereas the rotation speed of the boom pump 48p is controlled by the boom motor generator 87. Supply of a sufficient amount of hydraulic fluid to the head-side of the boom cylinder 8bmc is ensured, resulting in more efficient boom raising action.

At the return fluid passage 55 at that time, the boom control circuit 45 divides the return fluid discharged from the boom cylinder 8bmc, controls the proportion of divided flows of the fluid by the flow rate ratio control valve 58,59, and, by means of the return fluid in one of the divided flows, whose flow rate is controlled by the flow rate ratio control valve 58,59, drives the energy recovery motor 86. With the configuration as above, the boom control circuit 45 is capable of gradually increasing the flow rate proportion of the fluid distributed towards the energy recovery motor 86 side from the moment the return fluid starts to flow from the boom cylinder 8bmc, thereby preventing the occurrence of shock, as well as ensuring stable function of the boom cylinder 8bmc by preventing a sudden change in load to the boom cylinder 8bmc.

In other words, when the boom 8bm of the work equipment 8 descends due to its own weight, gradual increase of the flow rate proportion of the return fluid discharged from the head side of the boom cylinder 8bmc towards the energy recovery motor 86 side enables the energy recovery motor 86 to smoothly absorb the energy of the return fluid and prevent a sudden change in load to the boom cylinder 8bmc, stabilizing the descending action of the boom 8bm due to its own weight. In short, energy generated during descent of the boom can be stored independent of other circuits.

The solenoid valve 58 and the solenoid valve 59 of the flow rate ratio control valve 58,59 may each be disposed at desired, separate locations in the return passage 56 and the return passage 57 respectively. Furthermore, the flow rate ratio control valve 58,59 is capable of controlling return fluid flowing towards the energy recovery motor 86 side at a desired flow rate and flow rate ratio by controlling an aperture of each respective return passage 56,57 separately and independently of each other.

To stop the upper structure 4 when it is being rotated on the lower structure 2 by the swing motor generator 4sw functioning as an electric motor, the swing control circuit 28 operates the swing motor generator 4sw to function as a generator. Thus, the rotation of the upper structure 4 can be braked, while the electric power generated by the swing motor generator 4sw, together with the electric power generated by the boom motor generator 87, which is being driven by the energy recovery motor 86, can be efficiently recovered to the electric power storage device 23 and effectively regenerated as pump power for the hybrid drive system 10.

Furthermore, controlling the solenoid valve 74 between bucket and stick at the aforementioned position for enabling flow in a one-way direction enables hydraulic fluid that would otherwise be fed from the first main pump 17A to the bucket cylinder 8bkc to merge with the hydraulic fluid fed from the second main pump 17B to the stick cylinder 8stc, thereby increasing the speed of the stick cylinder 8stc. Furthermore, controlling the solenoid valve 74 between bucket and stick at the flow interruption position enables the bucket control circuit 47 and the stick control circuit 46 to function independently of each other, thereby separating the bucket system and the stick system so that pressures in the two systems can be controlled independently of each other.

Next, the embodiment shown in FIG. 5 is explained. As the work machine that employs this embodiment is the same as the one shown in FIG. 2, its explanation is omitted hereunder.

A hybrid drive system 10 shown in FIG. 5 comprises an engine 11, a clutch 12, a power transmission unit 14, and two main pumps 17A,17B of a variable delivery type. In the explanation hereunder, the main pumps 17A,17B may also be referred to as the first main pump and the second main pump, respectively. The clutch 12 is connected to the engine 11 and serves to transmit or interrupt rotational power output from the engine 11. An input axis 13 of the power transmission unit 14 is connected to the clutch 12, and an output axis 15 of the power transmission unit 14 is connected to the main pumps 17A,17B.

A motor generator 22 is connected to an input/output axis 21 of the power transmission unit 14 so that the motor generator 22 is arranged in parallel with the engine 11 with respect to the main pumps 17A,17B. The motor generator 22 is adapted to be driven by the engine 11 so as to function as a generator as well as receive electric power so as to function as an electric motor. The motor power of the motor generator 22 is set to be smaller than the engine power. A motor generator controller 22c, which may be an inverter or the like, is connected to the motor generator 22.

The motor generator controller 22c is connected to an electric power storage device 23, which may be a battery, a capacitor, or the like, through an electric power storage device controller 23c, which may be a converter or the like. The electric power storage device 23 serves to store electric power fed from the motor generator 22 functioning as a generator, as well as feed electric power to the motor generator 22 functioning as a motor.

The power transmission unit 14 of the hybrid drive system 10 incorporates a continuously variable transmission mechanism, such as a toroidal type, a planetary gear type, etc., so that, upon receiving a control signal from outside, the power transmission unit 14 is capable of outputting rotation of continuously varying speed to its output axis 15.

The main pumps 17A,17B of the hybrid drive system 10 serve to feed hydraulic fluid, such as hydraulic oil, that is contained in a tank 24 to a hydraulic actuator control circuit 25. The hydraulic actuator control circuit 25 includes an energy recovery motor 26. The energy recovery motor 26 is adapted to drive a boom motor generator 87. The boom motor generator 87 is provided with a boom motor generator controller 87c so that, when the energy recovery motor 26 drives the boom motor generator 87, electric power is recovered from the boom motor generator 87 through the boom motor generator controller 87c and stored in the electric power storage device 23.

A swing control circuit 28 is provided separately and independently from the hydraulic actuator control circuit 25. The swing control circuit 28 serves to feed electric power from the electric power storage device 23 of the hybrid drive system 10 to a swing motor generator 4sw so that the swing motor generator 4sw functions as an electric motor. Another function of the swing control circuit 28 is to recover to the electric power storage device 23 electric power generated by the swing motor generator 4sw functioning as a generator during braking of rotating motion of the upper structure 4.

The swing control circuit 28 includes the aforementioned swing motor generator 4sw and a swing motor generator controller 4swc, which may be an inverter or the like. The swing motor generator 4sw serves to rotate the upper structure 4 through a swing deceleration mechanism 4gr. The swing motor generator 4sw is adapted to be driven by electric power fed from the electric power storage device 23 of the hybrid drive system 10 so as to function as an electric motor. The swing motor generator 4sw is also adapted to function as a generator when being rotated by inertial rotation force so as to recover electric power to the electric power storage device 23.

Speed of the engine 11, engagement/disengagement by the clutch 12, and speed change by the power transmission unit 14 are controlled based on signals output from a controller (not shown).

The hydraulic actuator control circuit 25 shown in FIG. 5 includes pump passages 31,32, which are respectively connected to output ports of the main pumps 17A,17B. The pump passages 31,32 are also respectively connected to solenoid valves 33,34, which serve as proportional solenoid valves, as well as to a solenoid valve 35, which is adapted to function as a straight travel valve. The solenoid valves 33,34 are respectively disposed in bypass passages for returning hydraulic fluid to the tank 24.

Each solenoid valve 33,34 may function as a bypass valve. To be more specific, when there is no operating signal that signifies the operator operating any one of the corresponding hydraulic actuators 2trL,2trR,8bmc,8stc,8bkc, a control signal from the controller controls the valve to a fully open position so that the corresponding main pump passage 31,32 communicates with the tank 24. When the operator operates any hydraulic actuator 2trL,2trR,8bmc,8stc,8bkc, the corresponding solenoid valve 33,34 shifts towards a closed position in proportion to the magnitude of the operating signal.

When at the work position, i.e. the left position as viewed in FIG. 5, the solenoid valve 35 enables hydraulic fluid to be fed from the two main pumps 17A,17B to the hydraulic actuators 2trL,2trR,8bmc,8stc,8bkc. When the solenoid valve 35 is switched to the right position, i.e. the straight travel position, it permits one of the main pumps, i.e. the main pump 17B, to feed equally divided volume of hydraulic fluid to the two travel motors 2trL,2trR, thereby enabling the work machine 1 to travel straight.

The hydraulic actuator control circuit 25 includes a travel control circuit 36 and a work equipment control circuit 37. The travel control circuit 36 serves to control hydraulic fluid fed from the main pumps 17A,17B of the hybrid drive system 10 to the travel motors 2trL,2trR. The work equipment control circuit 37 serves to control hydraulic fluid fed from the main pumps 17A,17B of the hybrid drive system 10 to the work actuators 8bmc,8stc,8bkc, which serve to operate the work equipment 8.

The travel control circuit 36 includes solenoid valves 43,44 for controlling direction and flow rate of hydraulic fluid supplied respectively through travel motor hydraulic fluid feeding passages 41,42. The travel motor hydraulic fluid feeding passages 41,42 are drawn from the solenoid valve 35, which functions as a straight travel valve.

The work equipment control circuit 37 includes a boom control circuit 45, a stick control circuit 46, and a bucket control circuit 47. The boom control circuit 45 serves to control hydraulic fluid fed from the main pumps 17A,17B of the hybrid drive system 10 to the boom cylinder 8bmc. The stick control circuit 46 serves to control hydraulic fluid fed from the main pumps 17A,17B of the hybrid drive system 10 to the stick cylinder 8stc. The bucket control circuit 47 serves to control hydraulic fluid fed from the main pumps 17A,17B of the hybrid drive system 10 to the bucket cylinder 8bkc.

The boom control circuit 45 includes a solenoid valve 49 for controlling direction and flow rate of hydraulic fluid received through a boom cylinder hydraulic fluid feeding passage 48. The boom cylinder hydraulic fluid feeding passage 48 is drawn from the solenoid valve 35, which functions as a straight travel valve. The solenoid valve 49 is provided with hydraulic fluid feed/discharge passages 51,52, which respectively communicate with the head-side chamber and the rod-side chamber of the boom cylinder 8bmc.

A solenoid valve 53 that serves as a fall preventive valve is disposed in the head-side hydraulic fluid feed/discharge passage 51 so that when movement of the boom 8bm is stopped, the boom 8bm is prevented from descending due to its own weight by switching the solenoid valve 53 to a check valve position at the left side, at which the solenoid valve 53 functions as a check valve. A solenoid valve 54 that serves as a regeneration valve is disposed between the two hydraulic fluid feed/discharge passages 51,52 so that a part of the return fluid discharged from the head-side chamber of the boom cylinder 8bmc can be regenerated into the rod-side chamber by switching the solenoid valve 54 to the check valve position when the boom is lowered.

A return fluid passage 55 to which the fluid discharged from the boom cylinder 8bmc is branched is provided at the tank passage side of the solenoid valve 49. The return fluid passage 55 comprises two return passages 56,57, which are provided with a flow rate ratio control valve 58,59 for controlling a ratio of fluid that branches off into the return passages 56,57. The flow rate ratio control valve 58,59 is comprised of two flow control solenoid valves: a solenoid valve 58 disposed in the return passage 56, which is provided with the aforementioned energy recovery motor 26, and a solenoid valve 59 disposed in the return passage 57, which branches off the upstream side of the solenoid valve 58.

A boom assist pump 84 as for augmenting flow rate of hydraulic fluid is connected through a boom assist hydraulic fluid feeding passage 85 to the aforementioned boom cylinder hydraulic fluid feeding passage 48, which serves to feed hydraulic fluid from the main pumps 17A,17B of the hybrid drive system 10 to the boom cylinder 8bmc. A solenoid valve 86s that is disposed in a bypass passage and functions in a similar manner to the aforementioned solenoid valves 33,34 is also connected to the boom cylinder hydraulic fluid feeding passage 48.

The aforementioned boom motor generator 87 is connected to the energy recovery motor 26 provided in the return passage 56, through which return fluid discharged from the boom cylinder 8bmc flows. The boom motor generator 87 is adapted to be driven by the energy recovery motor 26 so as to function as a generator for feeding electric power to the electric power storage device 23 of the hybrid drive system 10 as well as driven by electric power fed from the electric power storage device 23 so as to function as an electric motor. The boom motor generator 87 is connected through a clutch 88 to the boom assist pump 84 as. The clutch 88 serves to transmit electric power from the boom motor generator 87 to the boom assist pump 84 as when the boom motor generator 87 functions as an electric motor. When the boom motor generator 87 functions as a generator, the clutch 88 serves to disengage the boom motor generator 87 from the boom assist pump 84 as.

When the energy recovery motor 26 is in operation, its rotation speed is controlled by the flow rate of return fluid in the return passage 56, the aforementioned flow rate being controlled by the flow rate ratio control valve 58,59. This energy recovery motor 26 drives the boom motor generator 87 so that electric power is fed from the boom motor generator 87 to the electric power storage device 23 of the hybrid drive system 10 and stored therein.

It is desirable for the energy recovery motor 26 to function when the solenoid valve 49, which is provided for controlling direction and flow rate of hydraulic fluid, is positioned at the right chamber position as viewed in FIG. 5. In other words, it is desirable that when the boom is lowered, the hydraulic fluid feed/discharge passage 51 at the head-side of the boom cylinder 8bmc communicate with the return fluid passage 55 so as to permit the return fluid discharged from the head-side of the boom cylinder 8bmc to drive the energy recovery motor 26 well within its capacity because of the dead weight of the boom.

The stick control circuit 46 includes a solenoid valve 62 for controlling direction and flow rate of hydraulic fluid received through a stick cylinder hydraulic fluid feeding passage 61. The stick cylinder hydraulic fluid feeding passage 61 is drawn from the solenoid valve 35, which functions as a straight travel valve. The solenoid valve 62 is provided with hydraulic fluid feed/discharge passages 63,64, which respectively communicate with the head-side chamber and the rod-side chamber of the stick cylinder 8stc. A solenoid valve 65 that serves as a regeneration valve for returning fluid from the rod side to the head side is disposed between the two hydraulic fluid feed/discharge passages 63,64 so that return fluid discharged from the rod-side chamber of the stick cylinder 8stc can be regenerated into the head-side chamber by switching the solenoid valve 65 to the check valve position when the stick is lowered by stick-in operation.

The bucket control circuit 47 includes a solenoid valve 67 for controlling direction and flow rate of hydraulic fluid received through a bucket cylinder hydraulic fluid feeding passage 66. The bucket cylinder hydraulic fluid feeding passage 66 is drawn from the solenoid valve 35, which functions as a straight travel valve. The solenoid valve 67 is provided with hydraulic fluid feed/discharge passages 68,69, which respectively communicate with the head-side chamber and the rod-side chamber of the bucket cylinder 8bkc.

A circuit-to-circuit communicating passage 71 between stick and boom is disposed between the stick cylinder hydraulic fluid feeding passage 61 and the head-side of the boom cylinder 8bmc and thereby provides fluid communication between them. A solenoid valve 72 between stick and boom is disposed in the circuit-to-circuit communicating passage 71 between stick and boom. The solenoid valve 72 between stick and boom is adapted to shift between a position for enabling flow in a one-way direction from the stick cylinder hydraulic fluid feeding passage 61 to the head-side of the boom cylinder 8bmc and a position for interrupting the flow of fluid.

A circuit-to-circuit communicating passage 73 between bucket and stick is disposed between the boom cylinder hydraulic fluid feeding passage 48 and the stick cylinder hydraulic fluid feeding passage 61 and thereby provides fluid communication between them. A solenoid valve 74 between bucket and stick is disposed in the circuit-to-circuit communicating passage 73 between bucket and stick. The solenoid valve 74 between bucket and stick is adapted to shift between a position for enabling flow in a one-way direction from the boom cylinder hydraulic fluid feeding passage 48 to the stick cylinder 8stc and a position for interrupting the flow of fluid.

A solenoid valve 89 between bucket and boom is disposed in the boom cylinder hydraulic fluid feeding passage 48, at a location between the branching point of the bucket cylinder hydraulic fluid feeding passage 66 and the joining point of the passage from the boom assist pump 84 as. The solenoid valve 89 between bucket and boom is adapted to shift between a position for enabling the hydraulic fluid that would otherwise be fed to the bucket cylinder 8bkc to be fed to the boom cylinder 8bmc in a one-way direction; a position for interrupting the flow of fluid; and a communicating position for enabling flow in both directions.

Each one of the solenoid valves 53,54,65,72,74,89 is a selector valve that incorporates a check valve and is capable of controlling flow rate.

Each one of the solenoid valves 33,34,35,43,44,49,53,54,58,59,62,65,67,72,74,86s,89 has a return spring (not shown) and a solenoid that is adapted to be proportionally controlled by the aforementioned controller (not shown) so that each solenoid valve is controlled at a position to achieve a balance between excitation force of the solenoid and restorative force of the spring.

Next, the functions and effects of the embodiment shown in FIG. 5 are explained hereunder.

When controlling hydraulic fluid fed from the main pumps 17A,17B of the hybrid drive system 10 to the travel motors 2trL,2trR, the boom cylinder 8bmc, the stick cylinder 8stc, and the bucket cylinder 8bkc, the hydraulic actuator control circuit 25 disengages the clutch 88. As a result, the energy recovery motor 26, which is being driven by return fluid discharged from the boom cylinder 8bmc, efficiently inputs driving power to the boom motor generator 87, which is under no-load condition, so that the generated electric power is stored in the electric power storage device 23 of the hybrid drive system 10. When the clutch 88 is engaged, electric power fed from the electric power storage device 23 of the hybrid drive system 10 enables the boom motor generator 87 to function as an electric motor to drive the boom assist pump 84 as so that hydraulic fluid is fed from the boom assist pump 84 as to the boom cylinder 8bmc. Thus, energy of the return fluid discharged from the boom cylinder 8bmc can be effectively recovered even in an open circuit.

The configuration described above is particularly beneficial when the boom 8bm of the work equipment 8 descends due to its own weight, because the energy recovery motor 26 enables the energy of the return fluid discharged from the head side of the boom cylinder 8bmc to be absorbed by the boom motor generator 87 and efficiently stored in the electric power storage device 23 of the hybrid drive system 10.

At that time, the return fluid discharged from the boom cylinder 8bmc into the return fluid passage 55 is divided into the return passage 56 and the return passage 57, and the proportion of divided flows of the fluid is controlled by the flow rate ratio control valve 58,59. With its flow rate being controlled by the flow rate ratio control valve 58,59, the fluid in the return passage 56 drives the energy recovery motor 26 so that the energy recovery motor 26 drives the boom motor generator 87 to feed electric power to the electric power storage device 23 of the hybrid drive system 10. Therefore, the configuration according to the present invention is capable of gradually increasing the flow rate proportion of the fluid distributed towards the energy recovery motor 26 side from the moment the return fluid starts to flow from the boom cylinder 8bmc, thereby preventing the occurrence of shock, as well as ensuring stable function of the boom cylinder 8bmc by preventing a sudden change in load to the boom cylinder 8bmc.

In other words, when the boom 8bm of the work equipment 8 descends due to its own weight, gradual increase of the flow rate proportion of the return fluid discharged from the head side of the boom cylinder 8bmc towards the energy recovery motor 26 enables the energy recovery motor 26 to smoothly absorb the energy of the return fluid and prevent a sudden change in load to the boom cylinder 8bmc, stabilizing the descending action of the boom 8bm due to its own weight.

The solenoid valve 58 and the solenoid valve 59 of the flow rate ratio control valve 58,59 may each be disposed at desired, separate locations in the return passage 56 and the return passage 57 respectively. Furthermore, the flow rate ratio control valve 58,59 is capable of controlling return fluid flowing towards the energy recovery motor 26 at a desired flow rate and flow rate ratio by controlling an aperture of each respective return passage 56,57 separately and independently of each other.

To stop the upper structure 4 when it is being rotated on the lower structure 2 by the swing motor generator 4sw functioning as an electric motor, the swing control circuit 28 operates the swing motor generator 4sw to function as a generator. Thus, the rotation of the upper structure 4 can be braked, while the electric power generated by the swing motor generator 4sw, together with the electric power generated by the boom motor generator 87, which is being driven by the energy recovery motor 26, can be efficiently recovered to the electric power storage device 23 of the hybrid drive system 10 and effectively regenerated as pump power for the hybrid drive system 10.

As the solenoid valve 89 between bucket and boom is disposed in the boom cylinder hydraulic fluid feeding passage 48, opening the solenoid valve 89 to the one-way direction flow position enables hydraulic fluid that would otherwise be fed from the first main pump 17A to the bucket cylinder 8bkc to merge through the solenoid valve 89 with the hydraulic fluid from the boom assist pump 84 as and be fed to the boom cylinder 8bmc. This feature is particularly effective in speeding up the boom raising action and thereby improving working efficiency, because the amount of hydraulic fluid fed through the left chamber of the directional control solenoid valve 49 to the head-side of the boom cylinder 8bmc is increased. Furthermore, a high pressure to the bucket cylinder 8bkc can be ensured by closing the solenoid valve 89.

As the solenoid valve 74 between bucket and stick is disposed in the circuit-to-circuit communicating passage 73 between bucket and stick, controlling the solenoid valve 74 at the one-way direction flow position and closing the solenoid valves 72,89 enables hydraulic fluid that would otherwise be fed from the first main pump 17A to the boom cylinder hydraulic fluid feeding passage 48 to flow through the solenoid valve 74 into the stick cylinder hydraulic fluid feeding passage 61 and merge with the hydraulic fluid fed from the second main pump 17B to the stick cylinder hydraulic fluid feeding passage 61, thereby feeding the combined hydraulic fluid to the stick cylinder 8stc and consequently increasing the speed of the stick cylinder 8stc. Thus, working efficiency can be improved.

Controlling the solenoid valve 74 at the flow interruption position separates the stick system from the boom system and the bucket system, thereby separating the stick system from the boom system and the bucket system so that the pressure in the stick system can be controlled independently of the pressures in the boom system and the bucket system. This is particularly effective for ensuring generation of a high pressure at the bucket cylinder 8bkc.

When the solenoid valve 35 for enabling straight travel is at the right position as viewed in FIG. 5, i.e. the straight travel position, equally divided volume of hydraulic fluid is fed from the second main pump 17B to the two travel motors 2trL,2trR, thereby enabling the work machine 1 to travel straight. Should the solenoid valves 49,62,67 be at their respective neutral positions so that no hydraulic fluid is fed to the work actuators 8bmc,8stc,8bkc while the solenoid valve 35 for enabling straight travel is at the left position, i.e. the position for work as well as high speed travel, the solenoid valve 89 and the solenoid valve 74 can be shifted to their respective communicating positions to enable the supplementary hydraulic fluid discharged from the boom assist pump 84 as to be fed through the solenoid valve 89 and the solenoid valve 74 and merged with the hydraulic fluid fed from the first main pump 17A and the second main pump 17B to the two travel motors 2trL,2trR. This configuration ensures that the hydraulic fluid required for high speed travel is supplied, and enables the main pumps 17A,17B to be made compact.

According to the embodiment described above, the solenoid valve 72 between stick and boom is disposed in the circuit-to-circuit communicating passage 71 between stick and boom for linking the stick cylinder hydraulic fluid feeding passage 61 and the head-side of the boom cylinder 8bmc. Therefore, in addition to the confluent flow of hydraulic fluid fed to the head-side of the boom cylinder 8bmc through the left chamber of the directional control solenoid valve 49, hydraulic fluid can be fed from the second main pump 17B through the solenoid valve 72 to the head-side of the boom cylinder 8bmc by controlling the solenoid valve 72 between stick and boom at the one-way direction flow position. The aforementioned confluent flow of hydraulic fluid is comprised of the hydraulic fluid that is discharged from the first main pump 17A, passes through the solenoid valve 89, and subsequently merges with the hydraulic fluid fed from the boom assist pump 84 as. As a result, the speed of boom raising action by the boom cylinder 8bmc is increased, and working efficiency is consequently improved. Furthermore, by closing the solenoid valve 72, supply of hydraulic fluid to the stick cylinder 8stc can be ensured, resulting in increased speed of the stick cylinder 8stc.

The boom control circuit 45 can be separated from the main pumps 17A,17B by closing the solenoid valves 72,89 to their respective flow interruption positions.

A variety of combinations of switched positions of the solenoid valves 72,74,89 increases flexibility of the combination of control circuits, enabling flexibility in making changes in the system configuration. Furthermore, using a hybrid system enables improved fuel efficiency of the engine 11.

Next, the embodiment shown in FIG. 6 is explained. As the work machine that employs this embodiment is the same as the one shown in FIG. 2, its explanation is omitted hereunder.

A hybrid drive system 10 shown in FIG. 6 comprises an engine 11, a clutch 12, a power transmission unit 14, and two main pumps 17A,17B of a variable delivery type. In the explanation hereunder, the main pumps 17A,17B may also be referred to as the first main pump and the second main pump, respectively. The clutch 12 is connected to the engine 11 and serves to transmit or interrupt rotational power output from the engine 11. An input axis 13 of the power transmission unit 14 is connected to the clutch 12, and an output axis 15 of the power transmission unit 14 is connected to the main pumps 17A,17B.

A motor generator 22 is connected to an input/output axis 21 of the power transmission unit 14 so that the motor generator 22 is arranged in parallel with the engine 11 with respect to the main pumps 17A,17B. The motor generator 22 is adapted to be driven by the engine 11 so as to function as a generator as well as receive electric power so as to function as an electric motor. The motor power of the motor generator 22 is set to be smaller than the engine power. A motor generator controller 22c, which may be an inverter or the like, is connected to the motor generator 22.

The motor generator controller 22c is connected to an electric power storage device 23, which may be a battery, a capacitor, or the like, through an electric power storage device controller 23c, which may be a converter or the like. The electric power storage device 23 serves to store electric power fed from the motor generator 22 functioning as a generator, as well as feed electric power to the motor generator 22 functioning as a motor.

The power transmission unit 14 of the hybrid drive system 10 incorporates a continuously variable transmission mechanism, such as a toroidal type, a planetary gear type, etc., so that, upon receiving a control signal from outside, the power transmission unit 14 is capable of outputting rotation of continuously varying speed to its output axis 15.

The main pumps 17A,17B of the hybrid drive system 10 serve to feed hydraulic fluid, such as hydraulic oil, that is contained in a tank 24 to a hydraulic actuator control circuit 25. The hydraulic actuator control circuit 25 includes an energy recovery motor 26. The energy recovery motor 26 is adapted to drive a boom motor generator 87. The boom motor generator 87 is provided with a boom motor generator controller 87c so that, when the energy recovery motor 26 drives the boom motor generator 87, electric power is recovered from the boom motor generator 87 through the boom motor generator controller 87c and stored in the electric power storage device 23.

Speed of the engine 11, engagement/disengagement by the clutch 12, and speed change by the power transmission unit 14 are controlled based on signals output from a controller (not shown).

The hydraulic actuator control circuit 25 shown in FIG. 6 includes pump passages 31,32, which are respectively connected to output ports of the main pumps 17A,17B. The pump passages 31,32 are also respectively connected to solenoid valves 33,34, which serve as proportional solenoid valves, as well as to a solenoid valve 35, which is adapted to function as a straight travel valve. The solenoid valves 33,34 are respectively disposed in bypass passages for returning hydraulic fluid to the tank 24.

Each solenoid valve 33,34 may function as a bypass valve. To be more specific, when there is no operating signal that signifies the operator operating any one of the corresponding hydraulic actuators 2trL,2trR,8bmc,8stc,8bkc, a control signal from the controller controls the valve to a fully open position so that the corresponding main pump passage 31,32 communicates with the tank 24. When the operator operates any hydraulic actuator 2trL,2trR,8bmc,8stc,8bkc, the corresponding solenoid valve 33,34 shifts towards a closed position in proportion to the magnitude of the operating signal.

When at the work position, i.e. the left position as viewed in FIG. 6, the solenoid valve 35 enables hydraulic fluid to be fed from the two main pumps 17A,17B to the hydraulic actuators 2trL,2trR,8bmc,8stc,8bkc. When the solenoid valve 35 is switched to the right position, i.e. the straight travel position, it permits one of the main pumps, i.e. the main pump 17B, to feed equally divided volume of hydraulic fluid to the two travel motors 2trL,2trR, thereby enabling the work machine 1 to travel straight.

The hydraulic actuator control circuit 25 includes a travel control circuit 36 and a work equipment control circuit 37. The travel control circuit 36 serves to control hydraulic fluid fed from the main pumps 17A,17B of the hybrid drive system 10 to the travel motors 2trL,2trR. The work equipment control circuit 37 serves to control hydraulic fluid fed from the main pumps 17A,17B of the hybrid drive system 10 to the work actuators 8bmc,8stc,8bkc, which serve to operate the work equipment 8.

The travel control circuit 36 includes solenoid valves 43,44 for controlling direction and flow rate of hydraulic fluid supplied respectively through travel motor hydraulic fluid feeding passages 41,42. The travel motor hydraulic fluid feeding passages 41,42 are drawn from the solenoid valve 35, which functions as a straight travel valve.

The work equipment control circuit 37 includes a boom control circuit 45, a stick control circuit 46, and a bucket control circuit 47. The boom control circuit 45 serves to control hydraulic fluid fed from the main pumps 17A,17B of the hybrid drive system 10 to the boom cylinder 8bmc. The stick control circuit 46 serves to control hydraulic fluid fed from the main pumps 17A,17B of the hybrid drive system 10 to the stick cylinder 8stc. The bucket control circuit 47 serves to control hydraulic fluid fed from the main pumps 17A,17B of the hybrid drive system 10 to the bucket cylinder 8bkc.

The boom control circuit 45 includes a solenoid valve 49 for controlling direction and flow rate of hydraulic fluid received through a boom cylinder hydraulic fluid feeding passage 48. The boom cylinder hydraulic fluid feeding passage 48 is drawn from the solenoid valve 35, which functions as a straight travel valve. The solenoid valve 49 is provided with hydraulic fluid feed/discharge passages 51,52, which respectively communicate with the head-side chamber and the rod-side chamber of the boom cylinder 8bmc.

A solenoid valve 53 that serves as a fall preventive valve is disposed in the head-side hydraulic fluid feed/discharge passage 51 so that when movement of the boom 8bm is stopped, the boom 8bm is prevented from descending due to its own weight by switching the solenoid valve 53 to a check valve position at the left side, at which the solenoid valve 53 functions as a check valve. A solenoid valve 54 that serves as a regeneration valve is disposed between the two hydraulic fluid feed/discharge passages 51,52 so that a part of the return fluid discharged from the head-side chamber of the boom cylinder 8bmc can be regenerated into the rod-side chamber by switching the solenoid valve 54 to the check valve position when the boom is lowered.

A return fluid passage 55 to which the fluid discharged from the boom cylinder 8bmc is branched is provided at the tank passage side of the solenoid valve 49. The return fluid passage 55 comprises two return passages 56,57, which are provided with a flow rate ratio control valve 58,59 for controlling a ratio of fluid that branches off into the return passages 56,57. The flow rate ratio control valve 58,59 is comprised of two flow control solenoid valves: a solenoid valve 58 disposed in the return passage 56, which is provided with the aforementioned energy recovery motor 26, and a solenoid valve 59 disposed in the return passage 57, which branches off the upstream side of the solenoid valve 58.

A boom assist pump 84 as for augmenting flow rate of hydraulic fluid is connected through a boom assist hydraulic fluid feeding passage 85 to the aforementioned boom cylinder hydraulic fluid feeding passage 48, which serves to feed hydraulic fluid from the main pump 17A of the hybrid drive system 10 to the boom cylinder 8bmc.

The aforementioned boom motor generator 87 is connected to the energy recovery motor 26 provided in the return passage 56, through which return fluid discharged from the boom cylinder 8bmc flows. The boom motor generator 87 is adapted to be driven by the energy recovery motor 26 so as to function as a generator for feeding electric power to the electric power storage device 23 of the hybrid drive system 10 as well as driven by electric power fed from the electric power storage device 23 so as to function as an electric motor. The boom motor generator 87 is connected through a clutch 88 to the boom assist pump 84 as. The clutch 88 serves to transmit electric power from the boom motor generator 87 to the boom assist pump 84 as when the boom motor generator 87 functions as an electric motor. When the boom motor generator 87 functions as a generator, the clutch 88 serves to disengage the boom motor generator 87 from the boom assist pump 84 as.

When the energy recovery motor 26 is in operation, its rotation speed is controlled by the flow rate of return fluid in the return passage 56, the aforementioned flow rate being controlled by the flow rate ratio control valve 58,59. This energy recovery motor 26 drives the boom motor generator 87 so that electric power is fed from the boom motor generator 87 to the electric power storage device 23 of the hybrid drive system 10 and stored therein.

It is desirable for the energy recovery motor 26 to function when the solenoid valve 49, which is provided for controlling direction and flow rate of hydraulic fluid, is positioned at the right chamber position as viewed in FIG. 6. In other words, it is desirable that when the boom is lowered, the hydraulic fluid feed/discharge passage 51 at the head-side of the boom cylinder 8bmc communicate with the return fluid passage 55 so as to permit the return fluid discharged from the head-side of the boom cylinder 8bmc to drive the energy recovery motor 26 well within its capacity because of the dead weight of the boom.

The stick control circuit 46 includes a solenoid valve 62 for controlling direction and flow rate of hydraulic fluid received through a stick cylinder hydraulic fluid feeding passage 61. The stick cylinder hydraulic fluid feeding passage 61 is drawn from the solenoid valve 35, which functions as a straight travel valve. The solenoid valve 62 is provided with hydraulic fluid feed/discharge passages 63,64, which respectively communicate with the head-side chamber and the rod-side chamber of the stick cylinder 8stc. A solenoid valve 65 that serves as a regeneration valve for returning fluid from the rod side to the head side is disposed between the two hydraulic fluid feed/discharge passages 63,64 so that the return fluid discharged from the rod-side chamber of the stick cylinder 8stc can be regenerated into the head-side chamber by switching the solenoid valve 65 to the check valve position when the stick is lowered by stick-in operation.

The bucket control circuit 47 includes a solenoid valve 67 for controlling direction and flow rate of hydraulic fluid received through a bucket cylinder hydraulic fluid feeding passage 66. The bucket cylinder hydraulic fluid feeding passage 66 is drawn from the solenoid valve 35, which functions as a straight travel valve. The solenoid valve 67 is provided with hydraulic fluid feed/discharge passages 68,69, which respectively communicate with the head-side chamber and the rod-side chamber of the bucket cylinder 8bkc.

A circuit-to-circuit communicating passage 71 between stick and boom is disposed between the stick cylinder hydraulic fluid feeding passage 61 and the head-side of the boom cylinder 8bmc and thereby provides fluid communication between them. A solenoid valve 72 between stick and boom is disposed in the circuit-to-circuit communicating passage 71 between stick and boom. The solenoid valve 72 between stick and boom is adapted to shift between a position for enabling flow in a one-way direction from the stick cylinder hydraulic fluid feeding passage 61 to the head-side of the boom cylinder 8bmc and a position for interrupting the flow of fluid.

A circuit-to-circuit communicating passage 73 between bucket and stick is disposed between the boom cylinder hydraulic fluid feeding passage 48 and the stick cylinder hydraulic fluid feeding passage 61 and thereby provides fluid communication between them. A solenoid valve 74 between bucket and stick is disposed in the circuit-to-circuit communicating passage 73 between bucket and stick. The solenoid valve 74 between bucket and stick is adapted to shift between a position for enabling flow in a one-way direction from the boom cylinder hydraulic fluid feeding passage 48 to the stick cylinder 8stc and a position for interrupting the flow of fluid.

A solenoid valve 89 between bucket and boom is disposed in the boom cylinder hydraulic fluid feeding passage 48, at a location between the branching point of the bucket cylinder hydraulic fluid feeding passage 66 and the joining point of the passage from the boom assist pump 84 as. The solenoid valve 89 between bucket and boom is adapted to shift between a position for enabling the hydraulic fluid that would otherwise be fed to the bucket cylinder 8bkc to be fed to the boom cylinder 8bmc in a one-way direction and a position for interrupting the flow of fluid.

A swing control circuit 91 is provided separately and independently from the hydraulic actuator control circuit 25. The swing control circuit 91 serves to control hydraulic fluid fed to a swing motor 4swh, which serves to rotate the upper structure 4 through a swing deceleration mechanism 4gr.

The swing control circuit 91 includes a solenoid valve 94 and a swing pump motor 95, wherein the solenoid valve 94 is included in a closed circuit 92,93 of the swing motor 4swh, and the swing pump motor 95 is connected through the solenoid valve 94 to the closed circuit 92,93. The solenoid valve 94 serves as a directional control valve that is also capable of flow control. The swing pump motor 95 serves as a pump for feeding hydraulic fluid to the swing motor 4swh and also as a hydraulic motor driven by hydraulic fluid discharged from the swing motor 4swh.

The solenoid valve 94 has a function of a restrictor valve whose aperture can be incrementally adjusted between two fully open positions for rotation to the right and rotation to the left, respectively, with a neutral position therebetween. When the solenoid valve 94 is at the neutral position, the passage between the swing pump motor 95 and the swing motor 4swh is interrupted.

A swing motor generator 96 is connected to the swing pump motor 95. The swing motor generator 96 is connected to a swing motor generator controller 96c, which may be an inverter or the like and is connected to the electric power storage device 23 of the hybrid drive system 10.

When rotation of the upper structure 4 is being braked, the swing pump motor 95 functions as a hydraulic motor to drive the swing motor generator 96 so that the swing motor generator 96 functions as a generator for feeding electric power to the electric power storage device 23 of the hybrid drive system 10. The swing motor generator 96 is also adapted to be driven by electric power fed from the electric power storage device 23, and, as a result, function as an electric motor to drive the swing pump motor 95 as a pump.

In other words, the electric power storage device 23 serves to store electric power fed from the swing motor generator 96 when the swing motor generator 96 functions as a generator, and feed electric power to the swing motor generator 96 when the swing motor generator 96 functions as an electric motor.

An exterior-connecting passage 97 for feeding hydraulic fluid to the hydraulic actuators 2trL,2trR of the lower structure 2 and the hydraulic actuators 8bmc,8stc,8bkc of the work equipment 8 is drawn from a pipeline between the swing pump motor 95 and the solenoid valve 94.

A connecting passage solenoid valve 98 is disposed in the exterior-connecting passage 97 and adapted so that its aperture can be adjusted between a one-way direction flow position for enabling the supply of fluid to the hydraulic actuators 2trL,2trR,8bmc,8stc,8bkc of the lower structure 2 and the work equipment 8 and a position for interrupting the flow of fluid.

A hydraulic fluid replenishment pump 99 that serves as a hydraulic fluid replenishment means for replenishing hydraulic fluid is connected to the pipeline between the swing pump motor 95 and the solenoid valve 94.

A pump-to-pump communicating passage 101 is provided between the boom assist hydraulic fluid feeding passage 85 of the boom assist pump 84 as and the discharge passage 31 of the first main pump 17A so that the pump-to-pump communicating passage 101 provides fluid communication between the two passages. A solenoid valve 102 between pumps is disposed in the pump-to-pump communicating passage 101. The solenoid valve 102 is adapted to shift between a position for enabling flow in a one-way direction from the boom assist hydraulic fluid feeding passage 85 of the boom assist pump 84 as to the discharge passage 31 of the first main pump 17A and a position for interrupting the flow of fluid.

Each one of the solenoid valves 53,54,65,72,74,89,98,102 is a selector valve that incorporates a check valve and is capable of controlling flow rate.

Each one of the solenoid valves 33,34,35,43,44,49,53,54,58,59,62,65,67,72,74,89,94,98,102 has a return spring (not shown) and a solenoid that is adapted to be proportionally controlled by the aforementioned controller (not shown) so that each solenoid valve is controlled at a position to achieve a balance between excitation force of the solenoid and restorative force of the spring.

Next, the operations and effects of the embodiment shown in FIG. 6 are explained hereunder.

When rotating the upper structure 4 on the lower structure 2 of the work machine 1, the solenoid valve 94 is controlled at a directional control position for rotation to the right or rotation to the left, while the swing motor 4swh is driven by hydraulic pressure generated by the swing pump motor 95, which is driven by electric power fed from the electric power storage device 23 of the hybrid drive system 10 through the swing motor generator 96. Thus, the upper structure 4 can be rotated solely and independently by the swing system. During braking operation to stop the upper structure 4, the connecting passage solenoid valve 98 is closed so that hydraulic fluid discharged from the swing motor 4swh as a result of the pumping function of the swing motor 4swh, which is rotated by inertial movement of the upper structure 4, operates the swing pump motor 95 as a hydraulic motor load, thereby making the swing motor generator 96 function as a generator. It is thus possible to transform inertial motion energy of the upper structure 4 to electric energy, thereby effectively recovering electric power to the electric power storage device 23 of the hybrid drive system 10 while braking rotation movement of the upper structure 4.

When the swing motor 4swh does not require a great amount of hydraulic fluid, the solenoid valve 94 and the connecting passage solenoid valve 98 are adjusted closer to the neutral position and the one-way direction flow position respectively, so that the swing pump motor 95 is driven as a pump by the swing motor generator 96 functioning as an electric motor. As a result, while being replenished with hydraulic fluid by the hydraulic fluid replenishment pump 99, the swing pump motor 95 discharges hydraulic fluid through the connecting passage solenoid valve 98 to the exterior-connecting passage 97, thereby enabling the hydraulic fluid to be directly fed to the hydraulic actuator control circuit 25 of the lower structure 2 and the work equipment 8, both of which require supply of hydraulic fluid.

To be more specific, as the exterior-connecting passage 97 is connected to the discharge passage 32 of the main pump 17B, which feeds hydraulic fluid to the boom cylinder 8bmc, the stick cylinder 8stc, and the travel motors 2trL,2trR, a sufficient amount of hydraulic fluid is fed to these hydraulic actuators from the main pumps 17A,17B, as well as the swing pump motor 95 functioning as a pump. As the swing pump motor 95 can function as a pump, the main pumps 17A,17B can be made correspondingly compact.

When controlling hydraulic fluid fed from the main pumps 17A,17B of the hybrid drive system 10 to the travel motors 2trL,2trR, the boom cylinder 8bmc, the stick cylinder 8stc, and the bucket cylinder 8bkc, the hydraulic actuator control circuit 25 disengages the clutch 88. As a result, the energy recovery motor 26, which is being driven by return fluid discharged from the boom cylinder 8bmc, efficiently inputs driving power to the boom motor generator 87, which is under no-load condition, so that the generated electric power is stored in the electric power storage device 23 of the hybrid drive system 10. Thus, energy of the return fluid discharged from the boom cylinder 8bmc can be effectively recovered.

The configuration described above is particularly beneficial when the boom 8bm of the work equipment 8 descends due to its own weight, because the energy recovery motor 26 enables the energy of the return fluid discharged from the head side of the boom cylinder 8bmc to be absorbed by the boom motor generator 87 and stored in the electric power storage device 23 of the hybrid drive system 10.

When the clutch 88 is engaged, electric power fed from the electric power storage device 23 of the hybrid drive system 10 enables the boom motor generator 87 to function as an electric motor to drive the boom assist pump 84 as so that hydraulic fluid is fed from the boom assist pump 84 as to the boom cylinder 8bmc. As a great amount of hydraulic fluid is thus fed to the boom cylinder 8bmc from four pumps, i.e. the boom assist pump 84 as in addition to the main pumps 17A,17B and the swing pump motor 95 functioning as a pump, the speed of boom raising action is further increased, resulting in increased working efficiency.

The return fluid discharged from the boom cylinder 8bmc into the return fluid passage 55 is divided into the return passage 56 and the return passage 57, and the proportion of divided flows of the fluid is controlled by the flow rate ratio control valve 58,59. With its flow rate being controlled by the flow rate ratio control valve 58,59, the fluid in the return passage 56 drives the energy recovery motor 26 so that the energy recovery motor 26 drives the boom motor generator 87 to feed electric power to the electric power storage device 23 of the hybrid drive system 10. Therefore, the configuration according to the present invention is capable of gradually increasing the flow rate proportion of the fluid distributed towards the energy recovery motor 26 side from the moment the return fluid starts to flow from the boom cylinder 8bmc, thereby preventing the occurrence of shock, as well as ensuring stable function of the boom cylinder 8bmc by preventing a sudden change in load to the boom cylinder 8bmc.

In other words, when the boom 8bm of the work equipment 8 descends due to its own weight, gradual increase of the flow rate proportion of the return fluid discharged from the head side of the boom cylinder 8bmc towards the energy recovery motor 26 side enables the energy recovery motor 26 to smoothly absorb the energy of the return fluid and prevent a sudden change in load to the head side of the boom cylinder 8bmc, stabilizing the descending action of the boom 8bm due to its own weight.

The solenoid valve 58 and the solenoid valve 59 of the flow rate ratio control valve 58,59 may each be disposed at desired, separate locations in the return passage 56 and the return passage 57 respectively. Furthermore, the flow rate ratio control valve 58,59 is capable of controlling return fluid flowing towards the energy recovery motor 26 side at a desired flow rate and flow rate ratio by controlling an aperture of each respective return passage 56,57 separately and independently of each other.

As the solenoid valve 89 between bucket and boom is disposed in the boom cylinder hydraulic fluid feeding passage 48, a combined amount of hydraulic fluid can be fed from the first main pump 17A and the boom assist pump 84 as to the boom cylinder 8bmc by opening the solenoid valve 89. Therefore, it is possible to increase the speed of boom raising action by the boom cylinder 8bmc and improve working efficiency. Furthermore, a high pressure to the bucket cylinder 8bkc can be ensured by closing the solenoid valve 89.

As the solenoid valve 72 between stick and boom is disposed in the circuit-to-circuit communicating passage 71 between stick and boom for linking the stick cylinder hydraulic fluid feeding passage 61 and the head-side of the boom cylinder 8bmc, controlling the solenoid valve 72 to the one-way direction flow position enables hydraulic fluid to be fed from the second main pump 17B through the solenoid valve 72 to the head-side of the boom cylinder 8bmc, in addition to the hydraulic fluid that is fed from the first main pump 17A and the boom assist pump 84 as through the left chamber of the solenoid valve 49 to the head-side of the boom cylinder 8bmc, thereby increasing the speed of boom raising action by the boom cylinder 8bmc and improving working efficiency. Furthermore, supply of hydraulic fluid from the second main pump 17B to the stick cylinder 8stc can be ensured by closing the solenoid valve 72.

As the solenoid valve 74 between bucket and stick is disposed in the circuit-to-circuit communicating passage 73 between bucket and stick, opening the solenoid valve 74 to the one-way direction flow position and closing the solenoid valves 72,89 enables hydraulic fluid that would otherwise be fed from the first main pump 17A to the boom cylinder 8bmc to merge with the hydraulic fluid fed from the second main pump 17B to the stick cylinder 8stc, thereby increasing the speed of the stick cylinder 8stc. Furthermore, closing the solenoid valve 74 between bucket and stick and opening the solenoid valves 72,89 enables hydraulic fluid that would otherwise be fed from the second main pump 17B to the stick cylinder 8stc to merge with the hydraulic fluid fed from the first main pump 17A to the head-side of the boom cylinder 8bmc through the boom cylinder hydraulic fluid feeding passage 48, the solenoid valve 89, and the left chamber of the solenoid valve 49, thereby increasing the speed of boom raising action. Thus, working efficiency can be improved.

When the solenoid valve 74 between bucket and stick is controlled at the flow interruption position so that the boom control circuit 45 and the stick control circuit 46 function independently of each other, it is possible to separate the boom system and the stick system and control pressures in the two systems independently of each other. Furthermore, a high pressure to the bucket cylinder 8bkc can be ensured by closing the solenoid valve 89 as well as the solenoid valve 74.

The solenoid valve 102 between pumps is provided in the pump-to-pump communicating passage 101. Therefore, when hydraulic fluid is not required for boom raising, opening the solenoid valve 102 enables the hydraulic fluid discharged from the boom assist pump 84 as to be combined with hydraulic fluid from the first main pump 17A, resulting in improved working efficiency. Furthermore, supply of a desired amount of hydraulic fluid to the boom cylinder 8bmc can be ensured by closing the solenoid valve 102.

As a result of the configuration that allows opening or closing the connecting passage solenoid valve 98 in addition to operation of the solenoid valve 72 between stick and boom, the solenoid valve 74 between bucket and stick, the solenoid valve 89 between bucket and boom, and the solenoid valve 102 between pumps described above, the flexibility allowed in the combination of circuits that support each other with hydraulic fluid is increased, making it easy to cope with demands for a wide variety of operation patterns.

The boom control circuit 45 can be completely separated from the main pumps 17A,17B by closing the solenoid valves 72,89,102 to their respective flow interruption positions.

When the solenoid valve 35 for enabling straight travel is at the right position as viewed in FIG. 6, i.e. the straight travel position, equally divided volume of hydraulic fluid is fed from the second main pump 17B to the two travel motors 2trL,2trR, thereby enabling the work machine 1 to travel straight. Should the solenoid valves 49,62,67 be at their respective neutral positions so that no hydraulic fluid is fed to the work actuators 8bmc,8stc,8bkc while the solenoid valve 35 for enabling straight travel is at the left position, i.e. the position for work as well as high speed travel, the solenoid valve 102 and the solenoid valve 74 can be shifted to their respective communicating positions to enable the supplementary hydraulic fluid discharged from the boom assist pump 84 as to be fed through the communicating position of the solenoid valve 102 and the communicating position of the solenoid valve 74 and merged with the hydraulic fluid fed from the first main pump 17A and the second main pump 17B to the two travel motors 2trL,2trR. This configuration ensures that the hydraulic fluid required for high speed travel is supplied, and enables the main pumps 17A,17B to be made compact.

As described above, a variety of combinations of switched positions of the solenoid valves 72,74,89,98,102 increases flexibility of the combination of control circuits, enabling flexibility in making changes in the system configuration. Furthermore, using a hybrid system enables improved fuel efficiency of the engine 11.

Next, the embodiment shown in FIG. 7 is explained. As the work machine that employs a hydraulic circuit according to this embodiment is the same as the one shown in FIG. 2, its explanation is omitted hereunder.

A hybrid drive system 10 shown in FIG. 7 comprises an engine 11, a clutch 12, a power transmission unit 14, and two main pumps 17A,17B of a variable delivery type. In the explanation hereunder, the main pumps 17A,17B may also be referred to as the first main pump and the second main pump, respectively. The clutch 12 is connected to the engine 11 and serves to transmit or interrupt rotational power output from the engine 11. An input axis 13 of the power transmission unit 14 is connected to the clutch 12, and an output axis 15 of the power transmission unit 14 is connected to the main pumps 17A,17B.

A motor generator 22 is connected to an input/output axis 21 of the power transmission unit 14 so that the motor generator 22 is arranged in parallel with the engine 11 with respect to the main pumps 17A,17B. The motor generator 22 is adapted to be driven by the engine 11 so as to function as a generator as well as receive electric power so as to function as an electric motor. The motor power of the motor generator 22 is set to be smaller than the engine power. A motor generator controller 22c, which may be an inverter or the like, is connected to the motor generator 22.

An electric power storage device 23, which may be a battery, a capacitor, or the like, is connected to the motor generator controller 22c through an electric power storage device controller 23c, which may be a converter or the like. The electric power storage device 23 serves to store electric power fed from the motor generator 22 functioning as a generator, as well as feed electric power to the motor generator 22 functioning as a motor.

The power transmission unit 14 of the hybrid drive system 10 incorporates a continuously variable transmission mechanism, such as a toroidal type, a planetary gear type, etc., so that, upon receiving a control signal from outside, the power transmission unit 14 is capable of outputting rotation of continuously varying speed to its output axis 15.

The main pumps 17A,17B of the hybrid drive system 10 serve to feed hydraulic fluid, such as hydraulic oil, that is contained in a tank 24 to a hydraulic actuator control circuit 25. The hydraulic actuator control circuit 25 includes an energy recovery motor 26, to which the aforementioned motor generator 22 of the hybrid drive system 10 is connected through a recovery clutch 111 and a rotary shaft 112. The recovery clutch 111 serves to enable or interrupt transmission of rotational power.

A swing control circuit 28 is provided separately and independently from the hydraulic actuator control circuit 25. The swing control circuit 28 serves to feed electric power from the electric power storage device 23 of the hybrid drive system 10 to a swing motor generator 4sw so that the swing motor generator 4sw functions as an electric motor. Another function of the swing control circuit 28 is to recover to the electric power storage device 23 electric power generated by the swing motor generator 4sw functioning as a generator during braking of rotating motion of the upper structure 4.

The swing control circuit 28 includes the aforementioned swing motor generator 4sw and a swing motor generator controller 4swc, which may be an inverter or the like. The swing motor generator 4sw serves to rotate the upper structure 4 through a swing deceleration mechanism 4gr. The swing motor generator 4sw is adapted to be driven by electric power fed from the electric power storage device 23 of the hybrid drive system 10 so as to function as an electric motor. The swing motor generator 4sw is also adapted to function as a generator when being rotated by inertial rotation force so as to recover electric power to the electric power storage device 23.

Speed of the engine 11, engagement/disengagement by the clutch 12, and speed change by the power transmission unit 14 are controlled based on signals output from a controller (not shown).

The hydraulic actuator control circuit 25 shown in FIG. 7 includes pump passages 31,32, which are respectively connected to output ports of the main pumps 17A,17B. The pump passages 31,32 are also respectively connected to solenoid valves 33,34, which serve as proportional solenoid valves, as well as to a solenoid valve 35, which is adapted to function as a straight travel valve. The solenoid valves 33,34 are respectively disposed in bypass passages for returning hydraulic fluid to the tank 24.

Each solenoid valve 33,34 may function as a bypass valve. To be more specific, when there is no operating signal that signifies the operator operating any one of the corresponding hydraulic actuators 2trL,2trR,8bmc,8stc,8bkc, a control signal from the controller controls the valve to a fully open position so that the corresponding main pump passage 31,32 communicates with the tank 24. When the operator operates any hydraulic actuator 2trL,2trR,8bmc,8stc,8bkc, the corresponding solenoid valve 33,34 shifts towards a closed position in proportion to the magnitude of the operating signal.

When at the work position, i.e. the left position as viewed in FIG. 7, the solenoid valve 35 enables hydraulic fluid to be fed from the two main pumps 17A,17B to the hydraulic actuators 2trL,2trR,8bmc,8stc,8bkc. When the solenoid valve 35 is switched to the right position, i.e. the straight travel position, it permits one of the main pumps, i.e. the main pump 17B, to feed equally divided volume of hydraulic fluid to the two travel motors 2trL,2trR, thereby enabling the work machine 1 to travel straight.

The hydraulic actuator control circuit 25 includes a travel control circuit 36 and a work equipment control circuit 37. The travel control circuit 36 serves to control hydraulic fluid fed from the main pumps 17A,17B of the hybrid drive system 10 to the travel motors 2trL,2trR. The work equipment control circuit 37 serves to control hydraulic fluid fed from the main pumps 17A,17B of the hybrid drive system 10 to the work actuators 8bmc,8stc,8bkc, which serve to operate the work equipment 8.

The travel control circuit 36 includes solenoid valves 43,44 for controlling direction and flow rate of hydraulic fluid supplied respectively through travel motor hydraulic fluid feeding passages 41,42. The travel motor hydraulic fluid feeding passages 41,42 are drawn from the solenoid valve 35, which functions as a straight travel valve.

The work equipment control circuit 37 includes a boom control circuit 45, a stick control circuit 46, and a bucket control circuit 47. The boom control circuit 45 serves to control hydraulic fluid fed from the main pumps 17A,17B of the hybrid drive system 10 to the boom cylinder 8bmc. The stick control circuit 46 serves to control hydraulic fluid fed from the main pumps 17A,17B of the hybrid drive system 10 to the stick cylinder 8stc. The bucket control circuit 47 serves to control hydraulic fluid fed from the main pumps 17A,17B of the hybrid drive system 10 to the bucket cylinder 8bkc.

The boom control circuit 45 includes a solenoid valve 49 for controlling direction and flow rate of hydraulic fluid received through a boom cylinder hydraulic fluid feeding passage 48. The boom cylinder hydraulic fluid feeding passage 48 is drawn from the solenoid valve 35, which functions as a straight travel valve. The solenoid valve 49 is provided with hydraulic fluid feed/discharge passages 51,52, which respectively communicate with the head-side chamber and the rod-side chamber of the boom cylinder 8bmc.

A solenoid valve 53 that serves as a fall preventive valve is disposed in the head-side hydraulic fluid feed/discharge passage 51 so that when movement of the boom 8bm is stopped, the boom 8bm is prevented from descending due to its own weight by switching the solenoid valve 53 to a check valve position at the left side, at which the solenoid valve 53 functions as a check valve. A solenoid valve 54 that serves as a regeneration valve is disposed between the two hydraulic fluid feed/discharge passages 51,52 so that a part of the return fluid discharged from the head-side chamber of the boom cylinder 8bmc can be regenerated into the rod-side chamber by switching the solenoid valve 54 to the check valve position when the boom is lowered.

A return fluid passage 55 to which the fluid discharged from the boom cylinder 8bmc is branched is provided at the tank passage side of the solenoid valve 49. The return fluid passage 55 comprises two return passages 56,57, which are provided with a flow rate ratio control valve 58,59 for controlling a ratio of fluid that branches off into the return passages 56,57. The flow rate ratio control valve 58,59 is comprised of two flow control solenoid valves: a solenoid valve 58 disposed in the return passage 56, which is provided with the aforementioned energy recovery motor 26, and a solenoid valve 59 disposed in the return passage 57, which branches off the upstream side of the solenoid valve 58.

When the energy recovery motor 26 is in operation, its rotation speed is controlled by the flow rate of return fluid in the return passage 56, the aforementioned flow rate being controlled by the flow rate ratio control valve 58,59.

It is desirable for the energy recovery motor 26 to function when the solenoid valve 49, which is provided for controlling direction and flow rate of hydraulic fluid, is positioned at the right chamber position as viewed in FIG. 7. In other words, it is desirable that when the boom is lowered, the hydraulic fluid feed/discharge passage 51 at the head-side of the boom cylinder 8bmc communicate with the return fluid passage 55 so as to permit the return fluid discharged from the head-side of the boom cylinder 8bmc to drive the energy recovery motor 26 well within its capacity because of the dead weight of the boom.

The stick control circuit 46 includes a solenoid valve 62 for controlling direction and flow rate of hydraulic fluid received through a stick cylinder hydraulic fluid feeding passage 61. The stick cylinder hydraulic fluid feeding passage 61 is drawn from the solenoid valve 35, which functions as a straight travel valve. The solenoid valve 62 is provided with hydraulic fluid feed/discharge passages 63,64, which respectively communicate with the head-side chamber and the rod-side chamber of the stick cylinder 8stc. A solenoid valve 65 that serves as a regeneration valve for returning fluid from the rod side to the head side is disposed between the two hydraulic fluid feed/discharge passages 63,64 so that the return fluid discharged from the rod-side chamber of the stick cylinder 8stc can be regenerated into the head-side chamber by switching the solenoid valve 65 to the check valve position when the stick is lowered by stick-in operation.

The bucket control circuit 47 includes a solenoid valve 67 for controlling direction and flow rate of hydraulic fluid received through a bucket cylinder hydraulic fluid feeding passage 66. The bucket cylinder hydraulic fluid feeding passage 66 is drawn from the solenoid valve 35, which functions as a straight travel valve. The solenoid valve 67 is provided with hydraulic fluid feed/discharge passages 68,69, which respectively communicate with the head-side chamber and the rod-side chamber of the bucket cylinder 8bkc.

A circuit-to-circuit communicating passage 71 between stick and boom is disposed between the stick cylinder hydraulic fluid feeding passage 61 and the head-side of the boom cylinder 8bmc and thereby provides fluid communication between them. A solenoid valve 72 between stick and boom is disposed in the circuit-to-circuit communicating passage 71 between stick and boom. The solenoid valve 72 between stick and boom is adapted to shift between a position for enabling flow in a one-way direction from the stick cylinder hydraulic fluid feeding passage 61 to the head-side of the boom cylinder 8bmc and a position for interrupting the flow of fluid.

A circuit-to-circuit communicating passage 73 between boom and stick is disposed between the boom cylinder hydraulic fluid feeding passage 48 and the stick cylinder hydraulic fluid feeding passage 61 and thereby provides fluid communication between them. A solenoid valve 74 between boom and stick is disposed in the circuit-to-circuit communicating passage 73 between boom and stick. The solenoid valve 74 between boom and stick is adapted to shift between a position for enabling flow in a one-way direction from the boom cylinder hydraulic fluid feeding passage 48 to the stick cylinder 8stc and a position for interrupting the flow of fluid.

Each one of the solenoid valves 53,54,65,72,74 is a selector valve that incorporates a check valve and is capable of controlling flow rate.

Each one of the solenoid valves 33,34,35,43,44,49,53,54,58,59,62,65,67,72,74 has a return spring (not shown) and a solenoid that is adapted to be proportionally controlled by the aforementioned controller (not shown) so that each solenoid valve is controlled at a position to achieve a balance between excitation force of the solenoid and restorative force of the spring.

Next, the operations and effects of the embodiment shown in FIG. 7 are explained hereunder.

At the return fluid passage 55, the boom control circuit 45 divides the return fluid discharged from the boom cylinder 8bmc, controls the proportion of divided flows of the fluid by the flow rate ratio control valve 58,59, and, by means of the return fluid in one of the divided flows, whose flow rate is controlled by the flow rate ratio control valve 58,59, drives the energy recovery motor 26 so that the energy recovery motor 26 directly drives the motor generator 22 of the hybrid drive system 10 through the recovery clutch 111. With the configuration as above, the boom control circuit 45 is capable of gradually increasing the flow rate proportion of the fluid distributed towards the energy recovery motor 26 side from the moment the return fluid starts to flow from the boom cylinder 8bmc, thereby preventing the occurrence of shock, as well as ensuring stable function of the boom cylinder 8bmc by preventing a sudden change in load to the boom cylinder 8bmc.

In other words, when the boom 8bm of the work equipment 8 descends due to its own weight, gradual increase of the flow rate proportion of the return fluid discharged from the head side of the boom cylinder 8bmc towards the energy recovery motor 26 side enables the energy recovery motor 26 to smoothly absorb the energy of the return fluid and prevent a sudden change in load to the boom cylinder 8bmc, stabilizing the descending action of the boom 8bm due to its own weight.

The solenoid valve 58 and the solenoid valve 59 of the flow rate ratio control valve 58,59 may each be disposed at desired, separate locations in the return passage 56 and the return passage 57 respectively. Furthermore, the flow rate ratio control valve 58,59 is capable of controlling return fluid flowing towards the energy recovery motor 26 side at a desired flow rate and flow rate ratio by controlling an aperture of each respective return passage 56,57 separately and independently of each other.

Engaging the recovery clutch 111 enables the energy recovery motor 26, which is operated by the return fluid discharged from the boom cylinder 8bmc of the hydraulic actuator control circuit 25, to directly drive the motor generator 22 of the hybrid drive system 10 through the recovery clutch 111, making it unnecessary for the excess energy of the hydraulic fluid to be transformed in the hydraulic actuator control circuit 25 into electric power. Therefore, the embodiment described above eliminates the necessity of providing a generator means in the hydraulic actuator control circuit 25 and improves energy efficiency.

When using the motor generator 22 of the hybrid drive system 10 as an electric motor, disengaging the recovery clutch 111 prevents the energy recovery motor 26 from applying a load to the motor generator 22, enabling the motor generator 22 to efficiently function as an electric motor by means of electric power fed from the electric power storage device 23.

To stop the upper structure 4 when it is being rotated on the lower structure 2 by the swing motor generator 4sw functioning as an electric motor, the swing control circuit 28 operates the swing motor generator 4sw to function as a generator. Thus, the rotation of the upper structure 4 can be braked, while the electric power generated by the swing motor generator 4sw, together with the electric power generated by the motor generator 22 of the hybrid drive system 10, which is being driven by the energy recovery motor 26 through the recovery clutch 111, can be efficiently recovered to the electric power storage device 23 and effectively regenerated as pump power for the hybrid drive system 10.

Furthermore, opening the solenoid valve 74 between boom and stick and closing the solenoid valve 72 between stick and boom enables hydraulic fluid that would otherwise be fed from the first main pump 17A to the boom cylinder 8bmc to merge with the hydraulic fluid fed from the second main pump 17B to the stick cylinder 8stc, thereby increasing the speed of the stick cylinder 8stc. Closing the solenoid valve 74 between boom and stick and opening the solenoid valve 72 between stick and boom enables the hydraulic fluid that would otherwise be fed from the second main pump 17B to the stick cylinder 8stc to merge with the hydraulic fluid that is discharged from the first main pump 17A and fed through the boom cylinder hydraulic fluid feeding passage 48 and the left chamber of the directional control solenoid valve 49 to the head-side of the boom cylinder 8bmc, speeding up the boom raising action.

Furthermore, controlling the solenoid valve 74 between boom and stick at the flow interruption position enables the boom control circuit 45 and the bucket control circuit 47 to function independently of the stick control circuit 46, thereby separating the stick system from the boom system and the bucket system so that the pressure in the stick system can be controlled independently of the pressures in the boom system and the bucket system. This feature is particularly effective in ensuring high pressure required by the bucket system.

As described above in each of the embodiments, the return fluid passage 55 for supplying return fluid during boom lowering is divided so as to comprise two return passages 56,57, in which a solenoid valve 58 and a solenoid valve 59 are respectively provided so that the solenoid valve 58 and the solenoid valve 59 are disposed in parallel. The solenoid valve 58 is connected to the tank 24 through the energy recovery motor 26 (86 in FIG. 4), which serves to recover energy of the return fluid when the boom is lowered. The other solenoid valve, i.e. the solenoid valve 59, is directly connected to the tank 24. The configuration enables the two solenoid valves 58,59 to control the flow rate balance, thereby ensuring smooth operation of the energy recovery motor 26 without imposing a shock to this motor 26 for recovering energy of return fluid. Control by the solenoid valves 58,59 also ensures smooth boom lowering action by preventing a sudden change in back pressure to the boom cylinder 8bmc.

FIG. 8 shows a variant of a hybrid drive system 10, wherein a first clutch 12a is connected to an engine 11 and serves to enable or interrupt transmission of rotational power output from the engine 11. An input axis 13 of a power transmission unit 14 is connected to the first clutch 12a. A plurality of main pumps 17A,17B of a variable delivery type are connected in series to an output axis 15 of a power transmission unit 14.

A starter motor generator 18 is connected in series to the engine 11. The starter motor generator 18 is adapted to be driven by the engine 11 so as to function as a generator. The starter motor generator 18 is also adapted to receive electric power so as to function as an electric motor to start up the engine 11. A starter motor generator controller 18c, which may be an inverter or the like, is connected to the starter motor generator 18.

A second clutch 12b is connected to an input/output axis 21 of the power transmission unit 14 so that the second clutch 12b is arranged in parallel with the first clutch 12a with respect to the power transmission unit 14. A motor generator 22 is connected to the second clutch 12b so that the motor generator 22 is arranged in parallel with the engine 11 with respect to the main pumps 17A,17B. The motor generator 22 is adapted to be driven by the engine 11 so as to function as a generator as well as receive electric power so as to function as an electric motor. The motor power of the motor generator 22 is set to be smaller than the engine power. A motor generator controller 22c, which may be an inverter or the like, is connected to the motor generator 22.

The starter motor generator controller 18c and the motor generator controller 22c are connected to an electric power storage device 23, which may be a battery, a capacitor, or the like, through an electric power storage device controller 23c, which may be a converter or the like. The electric power storage device 23 serves to store electric power fed from the starter motor generator 18 and the motor generator 22 respectively functioning as generators, as well as feed electric power to the starter motor generator 18 and the motor generator 22 respectively functioning as motors.

The power transmission unit 14 of the hybrid drive system 10 incorporates a continuously variable transmission mechanism, such as a toroidal type, a planetary gear type, etc., so that, upon receiving a control signal from outside, the power transmission unit 14 is capable of outputting rotation of continuously varying speed to its output axis 15.

The main pumps 17A,17B of the hybrid drive system 10 serve to feed hydraulic fluid, such as hydraulic oil, that is contained in a tank 24 to a hydraulic actuator control circuit 25. The hydraulic actuator control circuit 25 includes an energy recovery motor 26. The energy recovery motor 26 is adapted to drive a generator 27 so that, when the energy recovery motor 26 drives the generator 27, electric power is recovered from the generator 27 and stored in the electric power storage device 23.

A swing control circuit 28 is provided separately and independently from the hydraulic actuator control circuit 25. The swing control circuit 28 serves to feed electric power from the electric power storage device 23 of the hybrid drive system 10 to a swing motor generator 4sw so that the swing motor generator 4sw functions as an electric motor. Another function of the swing control circuit 28 is to recover to the electric power storage device 23 electric power generated by the swing motor generator 4sw functioning as a generator during braking of rotating motion of the upper structure 4.

The swing control circuit 28 includes the aforementioned swing motor generator 4sw and a swing motor generator controller 4swc, which may be an inverter or the like. The swing motor generator 4sw serves to rotate the upper structure 4 through a swing deceleration mechanism 4gr. The swing motor generator 4sw is adapted to be driven by electric power fed from the electric power storage device 23 of the hybrid drive system 10 so as to function as an electric motor. The swing motor generator 4sw is also adapted to function as a generator when being rotated by inertial rotation force so as to recover electric power to the electric power storage device 23.

Speed of the engine 11, engagement/disengagement by the first clutch 12a, and speed change by the power transmission unit 14 are controlled based on signals output from a controller 29.

As described above, the hybrid drive system 10 has a series system, in which the engine 11 and the starter motor generator 18 are connected in series, and a parallel system, in which the engine 11 and the motor generator 22 are both connected with the power transmission unit 14 in parallel so that, depending on the work, selection can be made between the series system and the parallel system by means of the first clutch 12a, which is provided between the engine 11 and the power transmission unit 14, and the second clutch 12b, which is provided between the motor generator 22 and the power transmission unit 14. When the series system is in operation, the engine power is transmitted through the starter motor generator 18 and then stored in the electric power storage device 23. When the parallel system is in operation, the engine power is transmitted through the motor generator 22 and then stored in the electric power storage device 23. This configuration thus enables the use of the merits of the two systems, depending on the work.

For example, during heavy load work imposing a heavy pump load, the main pumps 17A,17B are driven by three power sources by engaging both clutches 12a,12b and driving both the starter motor generator 18 and the starter motor generator 22 as electric motors so that the motor power from the starter motor generator 18 is input into a crank shaft of the engine 11 while the motor power from the motor generator 22 is input into the power transmission unit 14.

Should the power required by the main pumps 17A,17B be well within the engine power when the series system is in operation, the starter motor generator 18 is driven to function as a generator so that electric power generated by the starter motor generator 18 is stored in the electric power storage device 23. Should the engine power be insufficient to satisfy the power required by the main pumps 17A,17B, the starter motor generator 18 is driven to function as an electric motor to supplement the engine 11 with its power. Should this still be insufficient to satisfy the power required by the main pumps 17A,17B, both clutches 12a,12b are engaged to enable the motor generator 22 of the parallel system to function as an electric motor so that the engine 11 is supplemented by the power from the starter motor generator 18 as well as from the motor generator 22.

During light load work imposing a relatively light pump load, the main pumps 17A,17B is driven either by the engine 11 by engaging the first clutch 12a and disengaging the second clutch 12b, or by the motor generator 22 by engaging the second clutch 12b and disengaging the first clutch 12a.

Disengaging the first clutch 12a, which is provided between the engine 11 and the power transmission unit 14, and engaging the second clutch 12b enables the motor generator 22 to be run as an electric motor by the electric power stored in the electric power storage device 23, thereby operating the main pumps 17A,17B in a still environment where the engine 11 is in a stopped state. This feature is advantageous because, for example, should some problems arise with the engine 11, it enables work to be carried out until repairs to the engine 11 can be effected or low-noise operations are required in populated areas or during nighttime, where engine noises would cause problems.

Furthermore, it is possible to charge the electric power storage device 23 during operation of the work machine by operating the engine 11 to drive the starter motor generator 18 as a generator while the motor generator 22 is functioning as an electric motor to drive the main pumps 17A,17B with the first clutch 12a disengaged and the second clutch 12b engaged.

By engaging the first clutch 12a and disengaging the second clutch 12b, the engine 11 is enabled to drive the main pumps 17A,17B and thereby effectively bear the pump load alone, without being burdened by the motor generator 22.

Should there be little or no pump load when the two clutches 12a,12b are engaged, both the starter motor generator 18 and the motor generator 22 can be driven to function as generators so that the starter motor generator 18 and the motor generator 22 are supplied with the engine power and thereby efficiently charge the electric power storage device 23.

As described above, it is possible to obtain a great pump power by thus engaging the two clutches 12a,12b to simultaneously use the driving power of the engine 11 and the driving power of the motor generator 22 through the power transmission unit 14. The starter motor generator 18, which is connected in series to the engine 11, is capable of functioning as an electric motor to start up the engine 11, and, when the load applied to the engine is small, functioning as a generator that is driven by the engine 11. Furthermore, by disengaging the first clutch 12a, it is possible to drive the starter motor generator 18 to function as a generator independently of the hydraulic system so that the electric power storage device 23 can be efficiently charged by both the starter motor generator 18 and the motor generator 22.

The electric power storage device 23 is capable of storing electric power fed from the starter motor generator 18 and the motor generator 22 respectively functioning as generators, as well as storing electric power recovered from the generator 27, while the generator 27 is being driven by the energy recovery motor 26 in the hydraulic actuator control circuit 25. As the electric power storage device 23 is thus capable of receiving a sufficient amount of electric power, it enables the motor generator 22 to drive the pumps for a long period of time while the engine 11 is at a standstill.

Furthermore, to stop the upper structure 4 when it is being rotated on the lower structure 2 by the swing motor generator 4sw functioning as an electric motor, the swing control circuit 28 operates the swing motor generator 4sw to function as a generator. Thus, the rotation of the upper structure 4 can be braked, while the electric power generated by the swing motor generator 4sw, together with the electric power generated by the generator 27, which is being driven by the energy recovery motor 26, can be efficiently recovered to the electric power storage device 23 of the hybrid drive system 10 and regenerated as pump power for the hybrid drive system 10.

Although the present invention is suitable for hydraulic excavators, it is also applicable to other work machines, such as truck cranes.

1. A hydraulic circuit comprising:
a first return passage through which return fluid discharged from a hydraulic actuator flows;
an energy recovery motor provided in the return passage and adapted to be driven by energy contained in the return fluid;
a second return passage that branches off the first return passage at a location upstream of the energy recovery motor; and
a flow rate ratio control valve for controlling a flow rate ratio of a flow rate of the return fluid in the first return passage and a flow rate of the return fluid in the second return passage.

2. A hydraulic circuit as claimed in claim 1, wherein the flow rate ratio control valve comprises:
a solenoid valve for controlling a flow rate of the return fluid in the first return passage; and
another solenoid valve for controlling a flow rate of the return fluid in the second return passage.

3. A hydraulic circuit as claimed in claim 1, wherein:
the hydraulic actuator is a boom cylinder for vertically pivoting a boom of a work equipment that is attached to a machine body of a work machine; and
the energy recovery motor is disposed in a return passage provided for hydraulic fluid from the boom cylinder.

4. An energy recovery device comprising:
a hydraulic actuator adapted to be driven by hydraulic fluid supplied from a pump;
an energy recovery motor adapted to be driven by energy contained in return fluid discharged from the hydraulic actuator;
a motor generator adapted to be driven by the energy recovery motor so as to function as a generator for feeding electric power to an electric power storage device as well as be driven by electric power fed from the electric power storage device so as to function as an electric motor; and
a clutch that serves to transmit power from the motor generator to the pump when the motor generator is functioning as an electric motor, and disengage the motor generator from the pump when the motor generator is functioning as a generator.

5. An energy recovery device as claimed in claim 4, wherein:
the hydraulic actuator is a boom cylinder for vertically pivoting a boom of a work equipment that is attached to a machine body of a work machine; and
the energy recovery motor is disposed in a return passage provided for hydraulic fluid from the boom cylinder.

6. A hydraulic circuit for a work machine provided with a work equipment comprising a boom, a stick, and a bucket sequentially connected to one another; the boom being adapted to be pivoted by a boom cylinder, which is adapted to receive hydraulic fluid from a plurality of main pumps comprising a first main pump and a second main pump; the stick adapted to be pivoted by a stick cylinder; and the bucket adapted to be pivoted by a bucket cylinder; wherein the hydraulic circuit comprises:
a boom cylinder hydraulic fluid feeding passage for feeding hydraulic fluid from the first main pump to the boom cylinder;
a bucket cylinder hydraulic fluid feeding passage that branches off the boom cylinder hydraulic fluid feeding passage and serves to feed hydraulic fluid to the bucket cylinder;
a stick cylinder hydraulic fluid feeding passage for feeding hydraulic fluid from the second main pump to the stick cylinder;
a boom assist pump that, together with the first main pump, serves to feed hydraulic fluid to the boom cylinder hydraulic fluid feeding passage;
a solenoid valve between bucket and boom disposed in the boom cylinder hydraulic fluid feeding passage, at a location between a point at which the bucket cylinder hydraulic fluid feeding passage branches off and a point at which a passage from the boom assist pump joins the boom cylinder hydraulic fluid feeding passage, the solenoid valve between bucket and boom being adapted to shift between a position for enabling the hydraulic fluid that would otherwise be fed to the bucket cylinder to be fed to the boom cylinder in a one-way direction and a position for interrupting the flow of fluid;
a circuit-to-circuit communicating passage between stick and boom for providing fluid communication from the stick cylinder hydraulic fluid feeding passage to a head-side of the boom cylinder; and
a solenoid valve between stick and boom that is disposed in the circuit-to-circuit communicating passage between stick and boom and adapted to shift between a position for enabling the hydraulic fluid that would otherwise be fed to the stick cylinder to be fed to the head-side of the boom cylinder in a one-way direction and a position for interrupting the flow of fluid.

7. A hydraulic circuit for a work machine provided with a work equipment having a boom to be pivoted by a boom cylinder, which is adapted to receive hydraulic fluid from a plurality of main pumps comprising a first main pump and a second main pump, wherein the hydraulic circuit comprises:
a boom cylinder hydraulic fluid feeding passage for feeding hydraulic fluid from the first main pump to the boom cylinder;
a boom assist pump that, together with the first main pump, serves to feed hydraulic fluid to the boom cylinder hydraulic fluid feeding passage;
a solenoid valve adapted to shift between a communicating position for enabling hydraulic fluid discharged from the boom assist pump to merge with hydraulic fluid discharged from the first main pump, and a position for interrupting the flow of fluid;
another solenoid valve adapted to shift between a communicating position for enabling hydraulic fluid discharged from the first main pump to merge with hydraulic fluid discharged from the second main pump, and a position for interrupting the flow of fluid;
a pair of travel motors for traveling; and
a straight travel valve disposed in a passage that enables the first and second main pumps to communicate with the pair of travel motors, the straight travel valve being adapted to shift between:
a high-speed travel position for enabling, when the solenoid valves are at their respective communicating positions, supplementary fluid received from the boom assist pump through the solenoid valves to merge with hydraulic fluid fed from the first main pump and the second main pump to the pair of travel motors, and
a straight travel position for feeding equally divided volume of hydraulic fluid from either the first main pump or the second main pump to the pair of travel motors.

8. A hydraulic circuit for a work machine as claimed in claim 6, wherein the hydraulic circuit further includes:
an energy recovery motor adapted to be driven by energy contained in return fluid discharged from the boom cylinder;
a motor generator adapted to be driven by the energy recovery motor so as to function as a generator for feeding electric power to an electric power storage device as well as be driven by electric power fed from the electric power storage device so as to function as an electric motor; and
a clutch that serves to transmit power from the motor generator to the boom assist pump when the motor generator is functioning as an electric motor and disengage the motor generator from the boom assist pump when the motor generator is functioning as a generator.

9. A hydraulic circuit for a work machine as claimed in claim 7, wherein the hydraulic circuit further includes:
an energy recovery motor adapted to be driven by energy contained in return fluid discharged from the boom cylinder;
a motor generator adapted to be driven by the energy recovery motor so as to function as a generator for feeding electric power to an electric power storage device as well as be driven by electric power fed from the electric power storage device so as to function as an electric motor; and
a clutch that serves to transmit power from the motor generator to the boom assist pump when the motor generator is functioning as an electric motor and disengage the motor generator from the boom assist pump when the motor generator is functioning as a generator.
